(19) United States
(12) Patent Application Publication
(10) Pub. No.: US 2019/0306675 A1
(43) Pub. Date: Oct. 3, 2019

(54) DETECTING AND MITIGATING DRONE INTERFERENCE

(71) Applicant: Intel Corporation, Santa Clara, CA (US)

(72) Inventors: Feng Xue, Redwood City, CA (US); Mustafa Akdeniz, San Jose, CA (US); Jingwen Bai, San Jose, CA (US); Youn Hyoung Heo, San Jose, CA (US); Nageen Himayat, Fremont, CA (US); Po-Han Huang, Santa Clara, CA (US); Chang-Shen Lee, Santa Clara, CA (US); Victor Sergeev, Nizhny Novgorod (RU); Shu-Ping Yeh, Campbell, CA (US); Candy Yiu, Portland, OR (US)

(21) Appl. No.: 16/234,273

(22) Filed: Dec. 27, 2018

Related U.S. Application Data
(60) Provisional application No. 62/650,088, filed on Mar. 29, 2018.

(51) Int. Cl. H04W 4/40; H04B 17/318; H04B 17/345; H04W 36/30; H04W 36/12; G05D 1/10; B64C 39/02

(52) U.S. Cl. CPC H04W 4/40; H04B 17/318; H04B 17/345; H04W 36/30; B64C 2201/141; G05D 1/101; B64C 39/024; B64C 2201/122; H04W 36/12

(57) ABSTRACT

Apparatuses, systems and methods for mitigation and detection of drone-based interference are disclosed. An apparatus for a base station can include processing circuitry to encode a message to control a user equipment (UE) to measure received power received from a set of observed cells in a wireless communication network. Processing circuitry can further be configured to receive a report from the UE that includes received power for the set of observed cells. The processing circuitry can further determine interference power from the UE to a specified cell of the set of observed cells based on the report and further based on reported antenna gain. The processing circuitry can further determine whether to support communication of the UE within the wireless communication network based on the determined interference power from the UE. Other systems, methods and apparatuses are described.

### PRIORITY CLAIM

This application claims the benefit of priority to U.S. Provisional Patent Application Ser. No. 62/650,088, entitled “ELEVATION TRIGGERED FOR AERIAL UE” and filed on Mar. 29, 2018, which is incorporated herein by reference in its entirety.

### TECHNICAL FIELD

Some aspects of the present disclosure relate to drone communication. More specifically, some aspects relate to detection and mitigation of interference caused by drone communications.

### BACKGROUND

Users of cellular communication devices expect telecommunication carriers to provide constant and reliable cellular communication service. Drones, or unmanned aerial vehicles (UAVs), can help provide supplemental cellular communication services to increase reliability. However, because UAVs operate at a high altitude, UAVs can have line-of-sight channels to a large number of base stations on the ground. This can lead to interference issues for those base stations.

### BRIEF DESCRIPTION OF THE DRAWINGS

FIG. 1 is a block diagram of an exemplary radio architecture in accordance with some aspects.

FIG. 2 illustrates a front-end module circuitry for use in the exemplary radio architecture of FIG. 1 in accordance with some aspects.

FIG. 3 illustrates a radio IC circuitry for use in the exemplary radio architecture of FIG. 1 in accordance with some aspects.

FIG. 4 illustrates a baseband processing circuitry for use in the exemplary radio architecture of FIG. 1 in accordance with some aspects.

FIG. 5 illustrates a block diagram of an example machine for performing methods according to some aspects.

FIG. 6 illustrates an example of a user equipment (UE) device according to some aspects.

FIG. 7 illustrates an example UE and a base station (BS) such as an eNB or gNB according to some aspects.

FIG. 8 illustrates uplink/downlink correspondence in the UAV channel according to some aspects.

FIG. 9 illustrates a method for detecting UAV interference according to some aspects.

FIG. 10 illustrates refined UAV interference measurement in accordance with some aspects.

FIG. 11 illustrates base station side lobes and interference situations to be mitigated in accordance with some aspects.

FIG. 12 illustrates a three-dimensional map that is generated in accordance with some aspects.

FIG. 13 illustrates a method for reducing interference for a UAV having a directional antenna, according to some aspects.

FIG. 14 illustrates UAV uplink interference conditions that can be mitigated using methods according to some aspects.

FIG. 15 illustrates a method for performing inter-cell interference coordination (ICIC) according to some aspects.

FIG. 16 illustrates static and semi-static resource allocation for UAV uplink operation according to some aspects.

FIG. 17 illustrates dynamic resource allocation for UAV uplink operation according to some aspects.

FIG. 18 illustrates triggering of drone reports according to some aspects.

### DETAILED DESCRIPTION

Supporting unmanned aerial vehicles (UAVs) in cellular networks can be challenging. Because UAVs operate at high altitude, they are able to see, and therefore interfere with, several cells located on the ground. Direct measurement of this interference is challenging and mathematically complex, primarily due to the fact that the UAVs need to be identifiable by all affected cells. Described herein are solutions directed to reducing the complexity of and mitigating such interference measurements.

### Example Radio Architecture

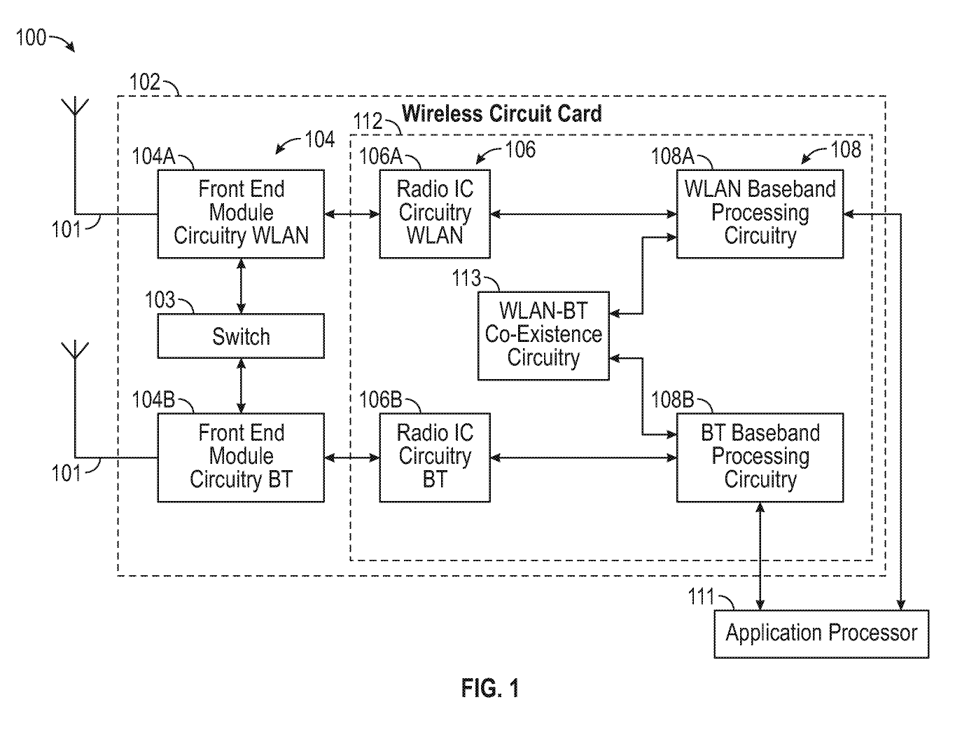

FIG. 1 is a block diagram of an exemplary radio architecture 100 in accordance with some aspects. Exemplary radio architecture 100 may include radio front-end module (FEM) circuitry 104, radio IC circuitry 106 and baseband processing circuitry 108. Exemplary radio architecture 100 as shown includes both Wireless Local Area Network (WLAN) functionality and Bluetooth (BT) functionality although aspects are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104B may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 102, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the aspect of FIG. 1, although FEM 104A and FEM 104B are shown as being distinct from one another, aspects are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106a may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the aspect of FIG. 1, although radio IC circuitries 106A and 106B are shown as being distinct from one another, aspects are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 110 for generation and processing of the baseband signals and for controlling operations of the radio IC circuitry 106.

Referring still to FIG. 1, according to the shown aspect, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, aspects include within their scope the sharing of one or more antennas as between the WLAN and BT FEMs, or the provision of more than one antenna connected to each of FEM 104A or 104B.

In some aspects, the front-end module circuitry 104, the radio IC circuitry 106, and baseband processing circuitry 108 may be provided on a single radio card, such as wireless radio card 102. In some other aspects, the one or more antennas 101, the FEM circuitry 104 and the radio IC circuitry 106 may be provided on a single radio card. In some other aspects, the radio IC circuitry 106 and the baseband processing circuitry 108 may be provided on a single chip or integrated circuit (IC), such as IC 112.

In some aspects, the wireless radio card 102 may include a WLAN radio card and may be configured for Wi-Fi communications, although the scope of the aspects is not limited in this respect. In some of these aspects, the exemplary radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier aspects, exemplary radio architecture 100 may be part of a Wi-Fi communication station (STA) such as a wireless access point (AP), a base station or a mobile device including a Wi-Fi device. In some of these aspects, exemplary radio architecture 100 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11ac, and/or 802.11 ax standards and/or proposed specifications for WLANs, although the scope of aspects is not limited in this respect. Exemplary radio architecture 100 may also be suitable to transmit and/or receive communications in accordance with other techniques and standards.

In some aspects, the exemplary radio architecture 100 may be configured for high-efficiency (HE) Wi-Fi (HEW) communications in accordance with the IEEE 802.1 lax standard. In these aspects, the exemplary radio architecture 100 may be configured to communicate in accordance with an OFDMA technique, although the scope of the aspects is not limited in this respect.

In some other aspects, the exemplary radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the aspects is not limited in this respect.

In some aspects, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In aspects that include BT functionality as shown for example in FIG. 1, the exemplary radio architecture 100 may be configured to establish a BT synchronous connection oriented (SCO) link and or a BT low energy (BT LE) link. In some of the aspects that include functionality, the exemplary radio architecture 100 may be configured to establish an extended SCO (eSCO) link for BT communications, although the scope of the aspects is not limited in this respect. In some of these aspects that include a BT functionality, the exemplary radio architecture may be configured to engage in a BT Asynchronous Connection-Less (ACL) communications, although the scope of the aspects is not limited in this respect. In some aspects, as shown in FIG. 1, the functions of a BT radio card and WLAN radio card may be combined on a single wireless radio card, such as single wireless radio card 102, although aspects are not so limited, and include within their scope discrete WLAN and BT radio cards

In some aspects, the exemplary radio architecture 100 may include other radio cards, such as a cellular radio card configured for cellular (e.g., 3GPP such as LTE, LTE-Advanced or 5G communications).

In some IEEE 802.11 aspects, the exemplary radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some aspects, a 320 MHz channel bandwidth may be used. The scope of the aspects is not limited with respect to the above center frequencies however.

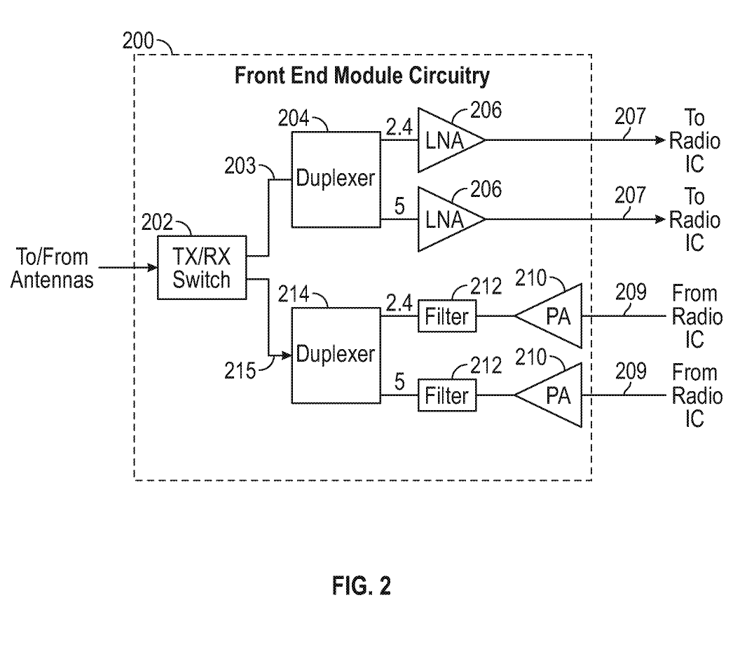

FIG. 2 illustrates FEM circuitry 200 in accordance with some aspects. The FEM circuitry 200 is one example of circuitry that may be suitable for use as the WLAN and/or BT FEM circuitry 104A/104B (FIG. 1), although other circuitry configurations may also be suitable.

In some aspects, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode aspects for Wi-Fi communication, the FEM circuitry 200 may be configured to operate in either the 2.4 GHz frequency spectrum or the 5 GHz frequency spectrum. In these aspects, the receive signal path of the FEM circuitry 200 may include a receive signal path duplexer 204 to separate the signals from each spectrum as well as provide a separate LNA 206 for each spectrum as shown. In these aspects, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some aspects, BT communications may utilize the 2.4 GHZ signal paths and may utilize the same FEM circuitry 200 as the one used for WLAN communications.

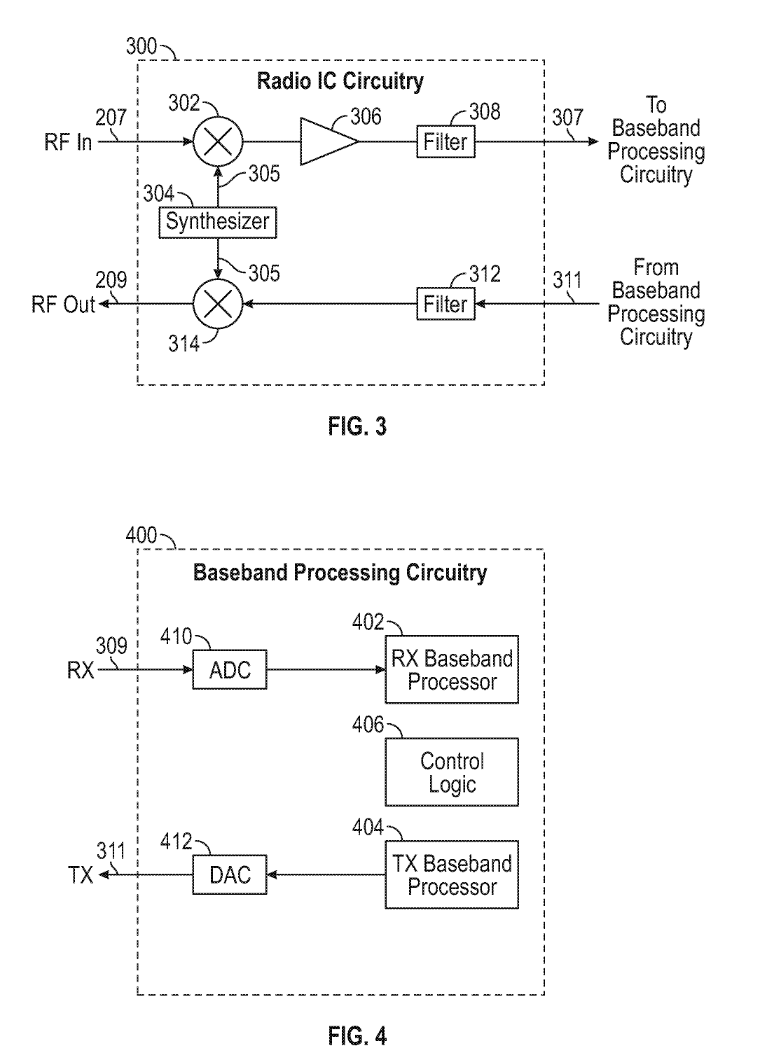

FIG. 3 illustrates radio IC circuitry 300 in accordance with some aspects. The radio IC circuitry 300 is one example of circuitry that may be suitable for use as the WLAN or BT radio IC circuitry 106A/106B (FIG. 1), although other circuitry configurations may also be suitable.

In some aspects, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some aspects, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, aspects where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some aspects, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some aspects, the output baseband signals 307 may be zero-frequency baseband signals, although this is not a requirement. In some aspects, mixer circuitry 302 may comprise passive mixers, although the scope of the aspects is not limited in this respect.

In some aspects, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the aspects is not limited in this respect.

In some aspects, the mixer circuitry 302 and the mixer circuitry 314 may each include two or more mixers and may be arranged for quadrature down-conversion and/or up-conversion respectively with the help of synthesizer 304. In some aspects, the mixer circuitry 302 and the mixer circuitry 314 may each include two or more mixers each configured for image rejection (e.g., Hartley image rejection). In some aspects, the mixer circuitry 302 and the mixer circuitry 314 may be arranged for direct down-conversion and/or direct up-conversion, respectively. In some aspects, the mixer circuitry 302 and the mixer circuitry 314 may be configured for super-heterodyne operation, although this is not a requirement.

Mixer circuitry 302 may comprise, according to one aspect: quadrature passive mixers (e.g., for the in-phase (I) and quadrature phase (Q) paths). In such an aspect, RF input signal 207 from FIG. 3 may be down-converted to provide I and Q baseband output signals to be sent to the baseband processor

Quadrature passive mixers may be driven by zero and ninety degree time-varying LO switching signals provided by a quadrature circuitry which may be configured to receive a LO frequency (fLO) from a local oscillator or a synthesizer, such as LO frequency 305 of synthesizer 304 (FIG. 3). In some aspects, the LO frequency may be the carrier frequency, while in other aspects, the LO frequency may be a fraction of the carrier frequency (e.g., one-half the carrier frequency, one-third the carrier frequency). In some aspects, the zero and ninety degree time-varying switching signals may be generated by the synthesizer, although the scope of the aspects is not limited in this respect.

In some aspects, the LO signals may differ in duty cycle (the percentage of one period in which the LO signal is high) and/or offset (the difference between start points of the period). In some aspects, the LO signals may have a 25% duty cycle and a 50% offset. In some aspects, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the aspects is not limited in this respect. The I and Q baseband output signals may be provided to low-nose amplifier, such as amplifier circuitry 306 (FIG. 3) or to filter circuitry 308 (FIG. 3).

In some aspects, the output baseband signals 307 and the input baseband signals 311 may be analog baseband signals, although the scope of the aspects is not limited in this respect. In some alternate aspects, the output baseband signals 307 and the input baseband signals 311 may be digital baseband signals. In these alternate aspects, the radio IC circuitry may include analog-to-digital converter (ADC) and digital-to-analog converter (DAC) circuitry.

In some dual-mode aspects, a separate radio IC circuitry may be provided for processing signals for each spectrum, or for other spectrums not mentioned here, although the scope of the aspects is not limited in this respect.

In some aspects, the synthesizer circuitry 304 may be a fractional-N synthesizer or a fractional N/N+1 synthesizer, although the scope of the aspects is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some aspects, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some aspects, frequency input into synthesizer circuitry 304 may be provided by a voltage controlled oscillator (VCO), although that is not a requirement. A divider control input may further be provided by either the baseband processing circuitry 108 (FIG. 1) or the application processor 110 (FIG. 1) depending on the desired output frequency 305. In some aspects, a divider control input (e.g., N) may be determined from a look-up table (e.g., within a Wi-Fi card) based on a channel number and a channel center frequency as determined or indicated by the application processor 110.

In some aspects, synthesizer circuitry 304 may be configured to generate a carrier frequency as the output frequency 305, while in other aspects, the output frequency 305 may be a fraction of the carrier frequency (e.g., one-half the carrier frequency, one-third the carrier frequency). In some aspects, the output frequency 305 may be a LO frequency (fLO).

FIG. 4 illustrates a functional block diagram of baseband processing circuitry 400 in accordance with some aspects. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some aspects (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these aspects, the baseband processing circuitry 400 may also include DAC 412 to convert digital baseband signals from the TX BBP 404 to analog baseband signals.

In some aspects that communicate OFDM signals or OFDMA signals, such as through baseband processor 108a, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some aspects, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some aspects, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals UE antennas In some multiple-input multiple-output (MIMO) aspects, the antennas may be effectively separated to take advantage of spatial diversity and the different channel characteristics that may result. Antennas 101 may each include a set of phased-array antennas, although aspects are not so limited.

Although the exemplary radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some aspects, the functional elements may refer to one or more processes operating on one or more processing elements.

### Example Machine Description

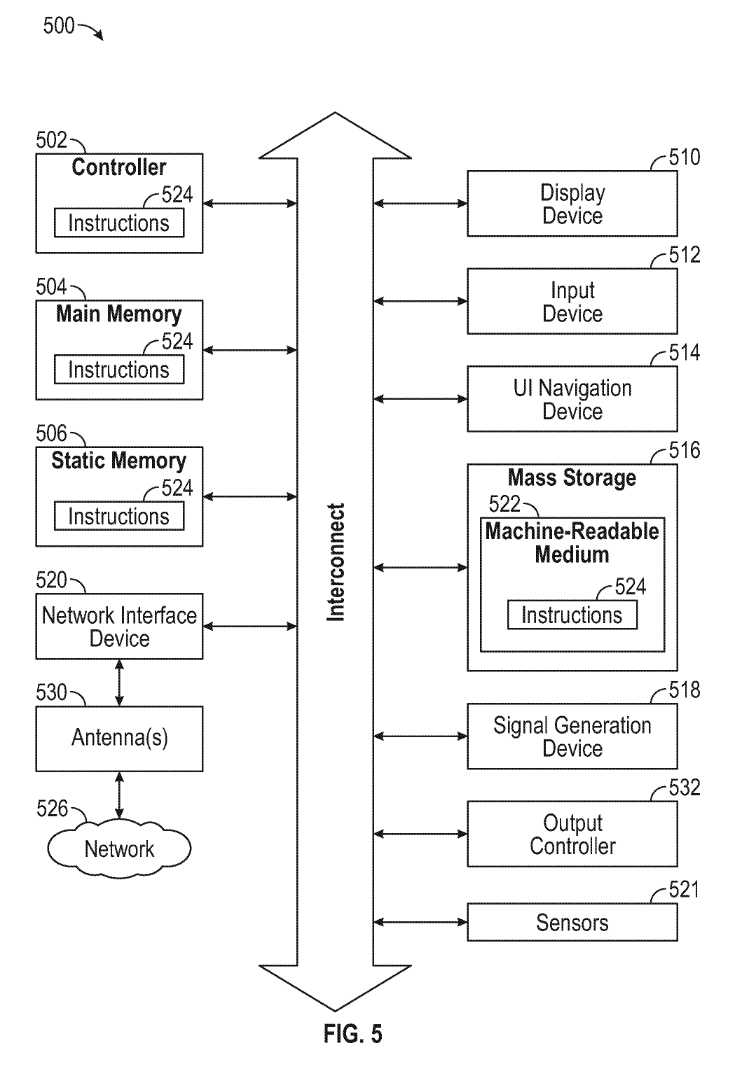

FIG. 5 illustrates a block diagram of an example machine 500 upon which any one or more of the techniques (e.g., methodologies) discussed herein may performed. In alternative aspects, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a user equipment (UE), evolved Node B (eNB), next generation evolved Node B (gNB), next generation access network (AN), next generation user plane function (UPF), Wi-Fi access point (AP), Wi-Fi station (STA), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521. The sensors 521 can include sensors capable of detecting location or for utilizing a service for detecting or determining location, such as a global positioning system (GPS) sensor, compass, accelerometer, or other sensor. The sensors 521 can include sensors capable of detecting elevation. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques. The term “transmission medium” shall be taken to include any intangible medium that is capable of storing, encoding, or carrying instructions for execution by the machine 500, and includes digital or analog communications signals or other intangible medium to facilitate communication of such software.

### Example UE Description

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

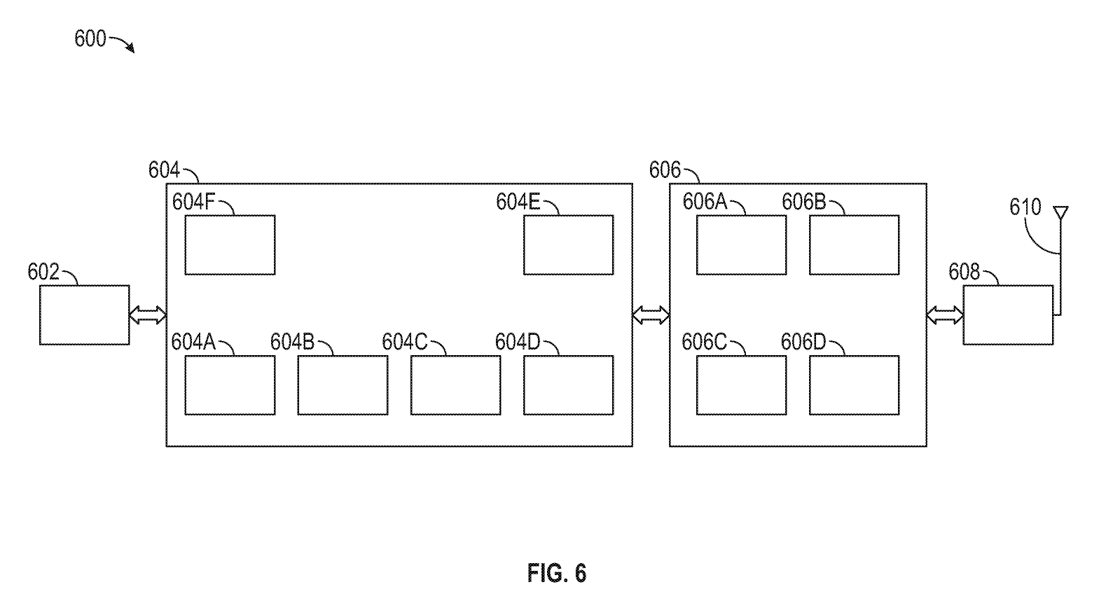

Aspects described herein may be implemented into a system using any suitably configured hardware and/or software. FIG. 6 illustrates, for one aspect, example components of a User Equipment (UE) device 600. In some aspects, the UE device 600 may include application circuitry 602, baseband circuitry 604, Radio Frequency (RF) circuitry 606, front-end module (FEM) circuitry 608 and one or more antennas 610, coupled together at least as shown. In some aspects, the UE can be a drone or UAV.

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 604 may include circuitry such as, but not limited to, one or more single-core or multi-core processors. The baseband circuitry 604 may include one or more baseband processors and/or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some aspects, the baseband circuitry 604 may include a second generation (2G) baseband processor 604a, third generation (3G) baseband processor 604b, fourth generation (4G) baseband processor 604c, and/or other baseband processor(s) 604d for other existing generations, generations in development or to be developed in the future (e.g., fifth generation (5G), 6G, etc.). The baseband circuitry 604 (e.g., one or more of baseband processors 604a-d) may handle various radio control functions that enable communication with one or more radio networks via the RF circuitry 606. The radio control functions may include, but are not limited to, signal modulation/demodulation, encoding/decoding, radio frequency shifting, etc. In some aspects, modulation/demodulation circuitry of the baseband circuitry 604 may include Fast-Fourier Transform (FFT), precoding, and/or constellation mapping/demapping functionality. In some aspects, encoding/decoding circuitry of the baseband circuitry 604 may include convolution, tail-biting convolution, turbo, Viterbi, and/or Low Density Parity Check (LDPC) encoder/decoder functionality. Aspects of modulation/demodulation and encoder/decoder functionality are not limited to these examples and may include other suitable functionality in other aspects.

In some aspects, the baseband circuitry 604 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 604e of the baseband circuitry 604 may be configured to run elements of the protocol stack for signaling of the PHY, MAC, RLC, PDCP and/or RRC layers. In some aspects, the baseband circuitry may include one or more audio digital signal processor(s) (DSP) 604f. The audio DSP(s) 604f may be include elements for compression/decompression and echo cancellation and may include other suitable processing elements in other aspects. Components of the baseband circuitry may be suitably combined in a single chip, a single chipset, or disposed on a same circuit board in some aspects. In some aspects, some or all of the constituent components of the baseband circuitry 604 and the application circuitry 602 may be implemented together such as, for example, on a system on a chip (SOC).

In some aspects, the baseband circuitry 604 may provide for communication compatible with one or more radio technologies. For example, in some aspects, the baseband circuitry 604 may support communication with an evolved universal terrestrial radio access network (EUTRAN) and/or other wireless metropolitan area networks (WMAN), a wireless local area network (WLAN), a wireless personal area network (WPAN). Aspects in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various aspects, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some aspects, the RF circuitry 606 may include a receive signal path and a transmit signal path. The receive signal path of the RF circuitry 606 may include mixer circuitry 606a, amplifier circuitry 606b and filter circuitry 606c. The transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some aspects, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some aspects, the output baseband signals may be zero-frequency baseband signals, although this is not a requirement. In some aspects, mixer circuitry 606a of the receive signal path may comprise passive mixers, although the scope of the aspects is not limited in this respect.

In some aspects, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c. The filter circuitry 606c may include a low-pass filter (LPF), although the scope of the aspects is not limited in this respect.

In some aspects, the mixer circuitry 606a of the receive signal path and the mixer circuitry 606a of the transmit signal path may include two or more mixers and may be arranged for quadrature downconversion and/or upconversion respectively. In some aspects, the mixer circuitry 606a of the receive signal path and the mixer circuitry 606a of the transmit signal path may include two or more mixers and may be arranged for image rejection (e.g., Hartley image rejection). In some aspects, the mixer circuitry 606a of the receive signal path and the mixer circuitry 606a may be arranged for direct downconversion and/or direct upconversion, respectively. In some aspects, the mixer circuitry 606a of the receive signal path and the mixer circuitry 606a of the transmit signal path may be configured for super-heterodyne operation.

In some aspects, the output baseband signals and the input baseband signals may be analog baseband signals, although the scope of the aspects is not limited in this respect. In some alternate aspects, the output baseband signals and the input baseband signals may be digital baseband signals. In these alternate aspects, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode aspects, a separate radio IC circuitry may be provided for processing signals for each spectrum, although the scope of the aspects is not limited in this respect.

In some aspects, the synthesizer circuitry 606d may be a fractional-N synthesizer or a fractional N/N+1 synthesizer, although the scope of the aspects is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some aspects, the synthesizer circuitry 606d may be a fractional N/N+1 synthesizer.

In some aspects, frequency input may be provided by a voltage controlled oscillator (VCO), although that is not a requirement. Divider control input may be provided by either the baseband circuitry 604 or the applications processor 602 depending on the desired output frequency. In some aspects, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some aspects, the divider may be a dual modulus divider (DMD) and the phase accumulator may be a digital phase accumulator (DPA). In some aspects, the DMD may be configured to divide the input signal by either N or N+1 (e.g., based on a carry out) to provide a fractional division ratio. In some example aspects, the DLL may include a set of cascaded, tunable, delay elements, a phase detector, a charge pump and a D-type flip-flop. In these aspects, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some aspects, synthesizer circuitry 606d may be configured to generate a carrier frequency as the output frequency, while in other aspects, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some aspects, the output frequency may be a LO frequency (fLO). In some aspects, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610.

In some aspects, the FEM circuitry 608 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610.

In some aspects, the UE device 600 may include additional elements such as, for example, memory/storage, display, camera, sensor, and/or input/output (I/O) interface.

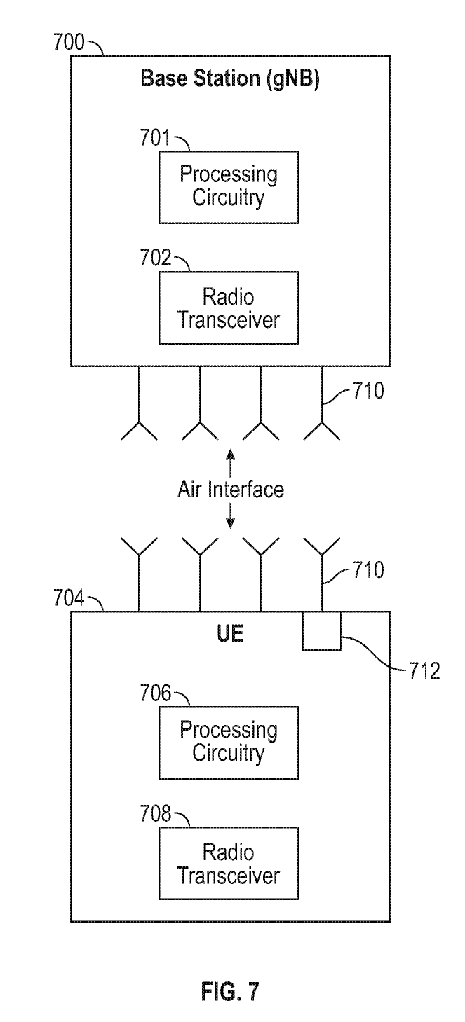

In Long Term Evolution (LTE) and 5G systems, a mobile terminal (referred to as a User Equipment or UE) connects to the cellular network via a base station (BS), referred to as an evolved Node B or eNB in LTE systems and as a next generation evolved Node B or gNB in 5G or NR systems. FIG. 7 illustrates an example of the components of a UE 1400 and a base station (e.g., eNB or gNB) 700. The BS 700 includes processing circuitry 701 connected to a radio transceiver 702 for providing an air interface. The UE 704 includes processing circuitry 706 connected to a radio transceiver 708 for providing an air interface over the wireless medium. Each of the transceivers in the devices is connected to antennas 710. The antennas 710 of the devices form antenna arrays whose directionality may be controlled by the processing circuitry. In examples, the antennas 710 can be coupled to electrical or mechanical apparatuses to tilt antennas 710 toward targeted cells. In examples, the antennas 710 can include at least two receiving antennas, and the at least two receiving antennas can include at least one omni-directional antenna and at least one directional antenna for measuring Reference Signal Received Power (RSRP) or a similar value. The memory and processing circuitries of the UE and/or BS may be configured to perform the functions and implement the schemes of the various aspects described herein. The UE can also be configured to operate as a drone or UAV.

### Descriptions of Aspects

### Exploiting Uplink/Downlink Correspondence in Detecting Drone Interference

Aspects provide methods to detect UAV-based or UAV-generated interference by using a phenomenon, known as uplink/downlink (UL/DL) channel correspondence, which occurs during UAV operation. A UE configured as a UAV will measure received power levels based on well-known reference signals from the cells, and selectively report to received power levels to a serving cell. With information on UL and DL antenna gain correspondence, supplied online or offline, the serving cell can determine the UAV-based interference level to the whole network, and, when needed, direct the UE and corresponding cell for further refined measurement. In some aspects, the serving cell can determine whether to admit UEs to the network, based on the above interference measurements. Methods and systems according to aspects can help avoid the cell coordination that would be required to perform direct interference measurement across several cells.

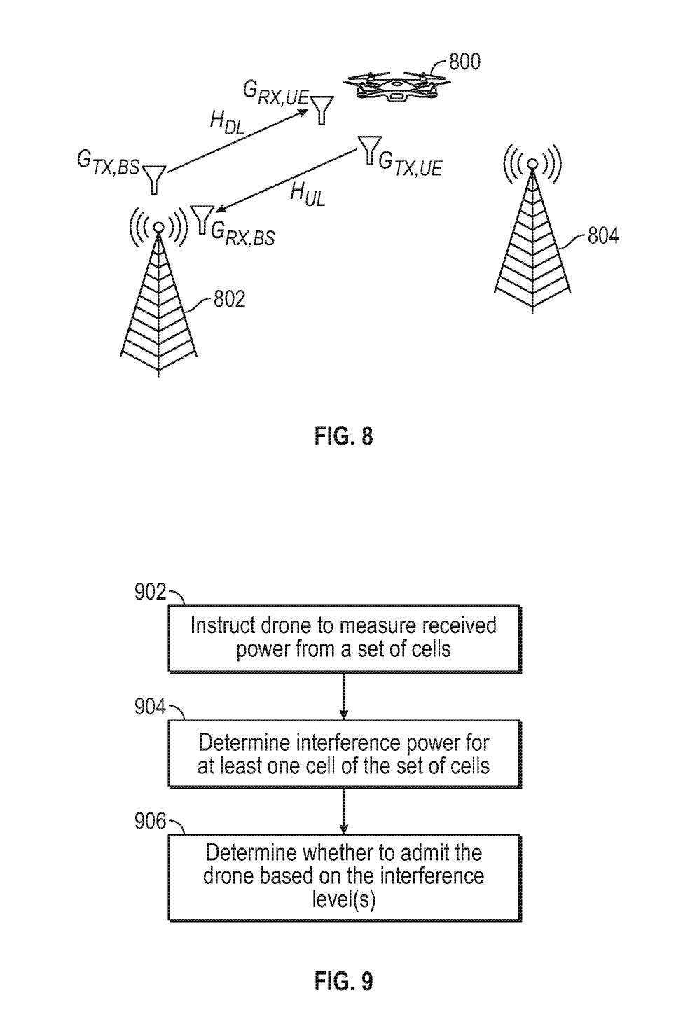

FIG. 8 illustrates uplink/downlink correspondence according to some aspects. BS 804 is another BS that can be seen by the UE 800. While only one other BS is shown, it will be appreciated that the UE 800 may have line-of-sight to any number of BS's.

The received power P_{RX,BS} at BS 802 from a particular UE 800, and the received power P_{RX,UE} at the UE 800 from a particular BS 802 are shown by Equations (1) and (2), in dB scale:

P_{RX,BS}=P_{TX,UE}+G_{TX,UE}−PathLoss+G_{RX,BS} (1)

P_{RX,UE}=P_{TX,BS}+G_{TX,BS}−PathLoss+G_{RX,UE} (2)

where P_{TX,UE} and P_{TX,BS} are the transmit powers at the UE 800 and the BS 802 respectively; G_{TX,UE} and G_{TX,BS} are the transmit antenna gains at the UE 800 and the BS 802 respectively; and G_{RX,UE} and G_{RX,BS} are the receive antenna gains at the UE 800 and the BS 802 respectively. H_{DL} and H_{UL} represent the channels on the downlink and uplink respectively. The corresponding pathloss in the downlink and uplink are 20*log₁₀|H_{DL}| and 20*log₁₀|H_{UL}|. In some use cases and in some aspects, H_{DL} and H_{UL} may be the same, in other words, values may be the same but phases may be different. Aspects are particularly directed to determining values for Equation (1), to detect UAV-based interference.

FIG. 9 illustrates a method 900 for detecting UAV interference according to some aspects. The method 900 can be performed by components of the base station 700 (FIG. 7), for example by processing circuitry 701.

The method 900 begins with operation 902 with the processing circuitry 701 encoding a message a message, for transmission to a UAV (e.g., UE 800) to instruct the UE 800 to measure received power received from a set of observed cells in a wireless communication network. In some scenarios, when the UE 800 connects to a serving cell (e.g., BS 802), the UE 800 can measure the received power levels from all cells whose received power level is above a predefined threshold level. The UE 800 can perform such measurements by default or based on an instruction by the processing circuitry 701. In some examples, the threshold level can be an absolute value P₀ measured in dB or dBm, or in some aspects, the threshold level can be relative to thermal noise level or other value.

The receive power from each cell can be based on reference signals such as cell-specific reference signals (CRS). The reported number can be Reference Signal Received Power (RSRP) or a similar value.

The UE 800 can provide a received power report to the serving cell. The received power report can be of the format shown in Table 1, although other received power report formats can be used:

TABLE 1
Drone report on Rx powers from neighboring cells.

| Cell ID | RX power in dB or dBm |
|---|---|
| eNB1 | 10 dB |
| . . . | |
| eNB2 | 5 dB |

The processing circuitry 701 can next determine antenna gains G_{TX,UE}, G_{TX,BS}, G_{RX,UE} and G_{RX,BS} as discussed above with reference to Equations (1) and (2). The processing circuitry 701 will use these antenna gains, and reported received power, to determine the interference power from the UE 800 to a particular cell. In some aspects, the UE 800 and BS 802 antenna patterns are known and stored in a database for later retrieval. In at least these aspects, the UE 800 may provide antenna orientation (e.g., the angle of the UE or UE antennas relative to the serving BS or other BS's) in a report having a format similar to that shown in Table 1 above. In some aspects, the antenna orientation report can be provided with (i.e., in a same message) the received power report.

In some aspects, when the UE 800 first connects to the network, the UE 800 can report the maximum difference between its transmit and receive antenna gains. In some aspects, the UE 800 can report transmit antenna gain and receive antenna gain in the same message in which the antenna orientation report or the received power report are provided. In at least these aspects, the UE 800 or the BS 802 can collect each cell's transmit and receive antenna gain. In some aspects, just the differences between transmit and receive antenna gains may be provided or reported.

In some aspects, when the UE 800 or BS 802 (or other BS's) use directional antennas or beamforming, the UE 800 can additionally report the orientation of transmit and receive antennas. The orientation reported can be the orientation relative to other cells, or an absolute orientation. In some aspects, the UE 800 can also report three-dimensional location, antenna patterns, beamforming values, and other data points.

Method 900 continues with operation 904 with the processing circuitry determining interference power, using data collected in operations described earlier herein. The projected interference power from the UE to a neighboring cell can be given by Equation (3):

P_{RX,BS}=P_{TX,UE}+G_{TX,UE}+(P_{RX,UE}−P_{TX,BS}−G_{TX,BS}−G_{RX,UE})+G_{RX,BS} (3)

where it can be assumed that the UE 800 transmit power information is known to serving BS 802.

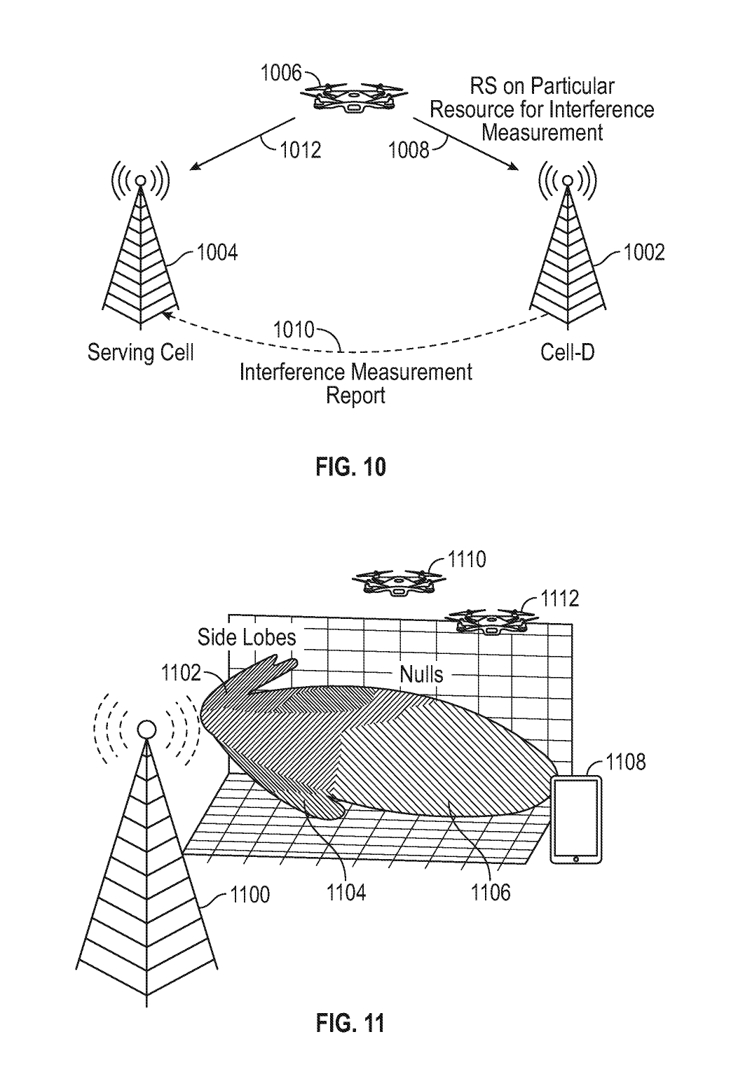

The processing circuitry 701 can determine whether to refine interference measurement based on the UE 800 report. For example, interference measurement may be refined based on reports provided in operation 902. The above determination is shown in more detail with respect to FIG. 10, which illustrates refined drone interference measurement in accordance with some aspects.

Referring to FIG. 10, In some examples, interference measurement may be refined for a subset of cells, including for example cell 1002. If the processing circuitry 1301 selects a cell for refinement, the serving cell 1004 can coordinate with that selected cell 1002 and with the UE 1006 to allocate UL resources (e.g., provide an UL resource grant) for the UE 800 transmission of a reference signal 1008. The selected cell 1002 will then measure the received power level based on that reference signal and provide a report 1010 to the serving cell. The serving cell 1004 may also request that the UE 1006 transmit reference signals on the uplink, collect received power reports from cells, and provide the collected reports 1012 to the serving cell 1004.

Referring again to FIG. 9, the method 900 continues with operation 906 with the serving cell (e.g., BS 802) making a determination as to whether to support the UE 800 (e.g., the BS 802 may make admissions decisions). In at least these aspects, for each impacted neighboring cell, BS 802 of the UE 800 will determine if the UE 800 will be supported. In some examples, the first cell to which the UE 800 tries to connect will make this admissions decision. In some aspects, the UE 800 link is denied or put on-hold if corresponding interference power to any neighboring cell is above a pre-defined value threshold, for example, relative to the thermal noise floor or other observable noise-based phenomenon.

In some aspects, admissions decisions take into account cell loading for all or a subset of the neighboring cells. If loading is below a certain value, then admissions decisions can be relaxed. In some aspects, UE 800 may be instructed to operate at lower transmission power, rather than being denied admission altogether. In some aspects, the UE 800 can be instructed to reduce emission power to some or a subset of cells, using beamforming or antenna orientation.

### Directional and Multi-Input/Multi-Output (MIMO) Antennas for Drone Support and Interference Mitigation

As mentioned earlier herein, UAVs are capable of detecting signals from several BS's. Even though BS antennas are down-tilted, UAVs can detect signals with strong signal-to-noise ratio (SNR) through BS side lobes, because path-loss in air is low and propagation is line-of-sight. Because of this strong detection of side lobes, UAVs can experience high interference of DL communications, and UAVs can themselves generate interference by UL communications. FIG. 11 illustrates base station side lobes and interference situations to be mitigated in accordance with some aspects. BS 1100 communicates on side lobes 1102, 1104 and main lobe 1106. Main lobe 1106 is directed downward to communicate with UE 1108 on the ground. Side lobe 1102 can communicate with UAVs 1110 and 1112, and therefore such communications can be subject to DL and UL interference.

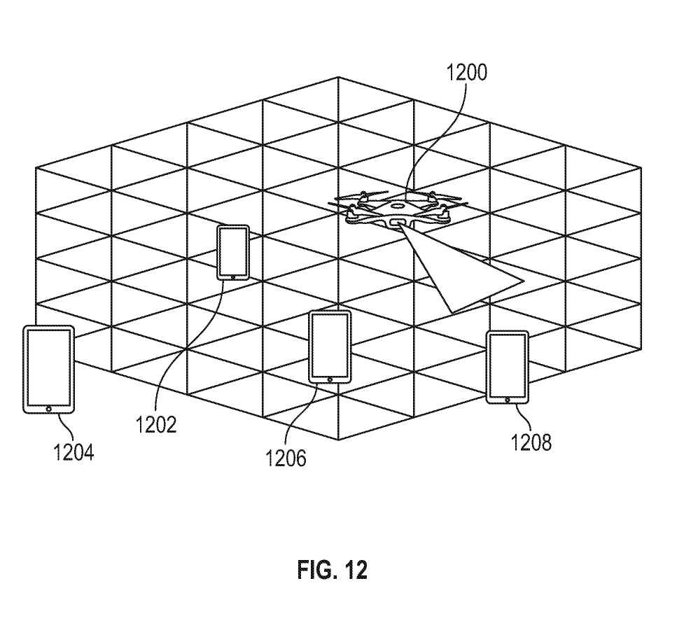

Methods and systems according to aspects can mitigate this interference by enhancing serving cell signals while reducing or minimizing UAV interference on the UL and DL. In some aspects, a UAV can implement a learning procedure to determine a direction to a best serving cell or subset of cells based on UAV location, serving cell location, or other criteria. In some aspects, cells can be prioritized for becoming the serving cell for a UAV based on these or other criteria. For example, as illustrated in FIG. 12, a UAV 1200 can generate or access a three-dimensional map as to determine a best serving cell among at least cells 1202, 1204, 1206 and 1208. The UAV can store knowledge learned in this procedure locally in memory or the UAV can communicate such knowledge to remote storage. The storage used can include main memory, static memory, or hardware processor storage of the UAV. Storage can include cloud storage. Storage can be in a centralized or distributed database, and/or associated caches and servers. Memory may include solid-state memories, and optical and magnetic media. Memory can include non-volatile memory, such as semiconductor memory devices and flash memory devices; magnetic disks, such as internal hard disks and removable disks. The UAV can retrieve location and priority information.

Subsequent to determining a direction to a best serving cell, a UAV 1200 can perform beamforming to adjust antenna direction toward the targeted serving cell. Cells can implement methods such as Coordinated Multi-point transmission/reception (CoMP) procedures including, for example, join transmission and joint reception. The UAV 1200 can adjust beamforming and beam alignment by communicating with the selected best serving cell. For example, the UAV 1200 can apply the current channel quality indicator (CQI) feedback loop to determine a precoding matrix index (PMI) or modulation and coding scheme (MCS). In other aspects, the UAV 1200 can report position, direction, or other information for the UAV 1200 or for a set of BS's on the UL to a serving cell, and the serving cell can determine which of those BS's to join with in a joint transmission scheme or joint reception scheme. In other aspects, if the UAV 1200 includes directional antennas, the UAV 1200 can tilt an antenna toward the serving cell based on procedures described later herein.

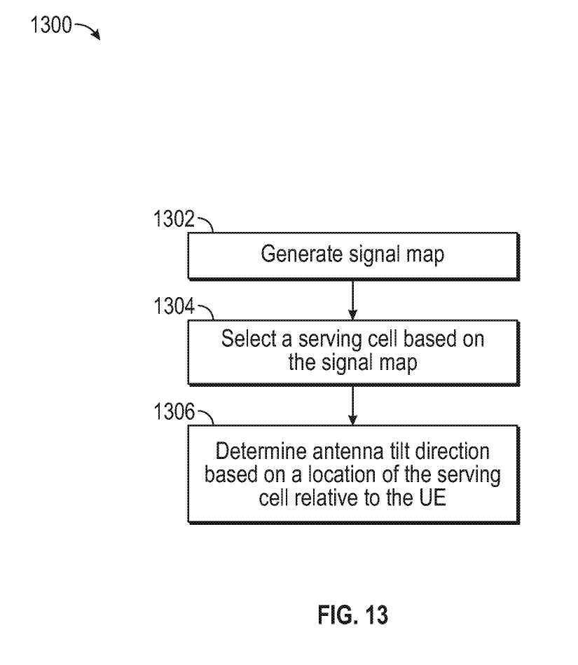

FIG. 13 illustrates a method 1300 for reducing interference for a UAV having a directional antenna, according to some aspects. The method 1300 can be performed by components of the UE 704, such as processing circuitry 706.

The method 1300 begins with operation 1302 with the processing circuitry 706 generating a signal map (e.g., a 3D signal map). A UE can collect information for a set of selected positions. The information can include cell quality indicators (based on, for example, CRS strength) and a cell ID for cells within a region that have a strength or readability above a threshold. The threshold can be defined based on reference signal receive quality (RSRQ) or RSRP-based values, for example. In some aspects, the number of cells represented in the signal map can be limited to a value K. The map generated can be similar to or include features of the map depicted in FIG. 12. A complete map can be generated based on limited observations, using extrapolation, conditional random field (CRF) methods, clustering methods, K means, etc. Data representative of the map can be stored locally at the UE or in a serving cell, or remotely in a table at least somewhat similar to example Table 2. For example, the data can be reported to a BS for central control. In example Table 2, cells can be sorted by quality, and a number of cells K can be included. Information such as a cell identifier (cell ID) and position can be included for each cell. However, other information can be included such as measurement values, antenna orientation, antenna pattern, or other data.

TABLE 2
Cell quality and position.

| | | Target Cell 2 | | |
|---|---|---|---|---|
| Position | Target Cell 1 | (next best | | Target Cell |
| in the air | (best quality) | quality) | . . . | K. |
| (x, y, z) | (cell ID, | (cell ID, | (cell ID, | (cell ID, |
| | position, | position, | position, | position, |
| | height, | height, | height, | height, |
| | quality | quality | quality | quality |
| | index) | index) | index) | index) |

In aspects, the UE or a serving BS can determine the best target cell(s) for any given position (x₀, y₀, z₀) in the air based on Table 2.

The map information and the (trained) interpolation method/parameters are communicated to a UE when the UE firsts attaches to the network, with an initial access procedure. In some aspects, YE initial access may not be directional. After initial access, the BS or UE can contribute information to update the map. If more than one UE is present, the multiple UEs can communicate map information to each other directly using a directional radio access technology (RAT).

A serving BS can determine whether a UE is a UAV (as opposed to a ground-based UE) and providing UAV-optimized signaling if the UE is a UAV. The BS processing circuitry 701 can learn this through signaling, learning, or another method. If the UE is a UAV, then certain limitations or criteria can be placed on UAV communication. For example, uplink and downlink transmit rank indicators can be set, or the channel can be assumed to be flat-fading and resource allocation can assume wideband allocation or other allocation types.

The method 1300 can continue with operation 1304 with the processing circuitry 706 selecting a serving cell based on the 3D map generated in operation 1302. The method 1300 can continue with operation 1306 with the processing circuitry performing beam tracking or beam forming based at least in part on the relative location of the selected serving cell. The beam tracking and beam forming may occur prior to other UE/BS interaction. During a flight, the UE 704 can target serving cells using information stored in Table 2 described earlier herein, in combination with real-time location information and other available metrics, to determine or alter tilt direction or other parameters of antennas 710. For example, depending on the location of projected target cells, the UE can mechanically or electrically tilt antenna/s 710 using tilt mechanism 712 so that the boresight of antenna/s 710 is roughly facing the target cell(s). For UEs supporting MIMO, the UE can pre-code transmission (or reception) towards the desired direction using pre-coding matrices F_{R0} (for reception) and F_{T0} (for transmission), such that the signal F_{R0} Y coming from (or F_{T0} X going to) a targeted cell is amplified (e.g., the eigen direction is toward the desired target cell). After beam forming, the UE can perform measurements and establish and maintain connections using standards-based signaling.

Once the UE is connected with the network, subsequent to operation 1304, the UE can refine beam tracking and beamforming. On the uplink, the UE can receive instructions from the serving BS to use particular MCSs, precoding matrix indicators (PMI), rank indicators (RIs), etc. In some aspects, the UE can report 3D position, antenna direction, preferred cells (based on signal quality), etc. The serving cell can use that reported information to coordinate with selected cells to establish joint reception from the target cells using CoMP. In some aspects, whether in uplink or downlink usage, the UE can mechanically maneuver antennas based on CQI procedures. On the downlink, the serving BS can instruct the UE to use particular MCS/PMI/RI, based on certain complexity-reducing assumptions such as flat channel and line-of-sight assumptions. As with uplink adjustments, on the downlink the UE can provide reports and the serving call can coordinate joint reception using CoMP.

### UAV Inter-Cell Interference Coordination for Uplink Wireless Communication

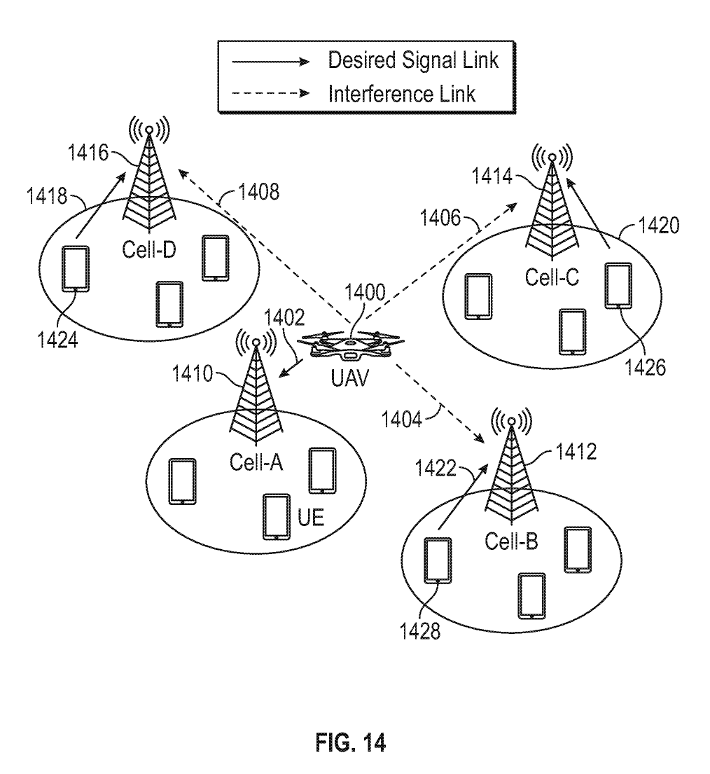

FIG. 14 illustrates UAV uplink interference conditions that can be mitigated using methods according to some aspects. UAV 1400 can communicate on uplink connections 1402, 1404, 1406 and 1408 to cells 1410, 1412, 1414 and 1416. Cells 1410, 1412, 1414 and 1416 can include circuitry at least somewhat similar to BS 700 circuitry (FIG. 7).

As described earlier herein, interference in the uplink is increased as more cells 1410, 1412, 1414 and 1416 become visible to the UAV 1400 due to line-of-sight propagation conditions. This can interfere with communication links 1418, 1420 and 1422 from ground-based UEs 1424, 1426 and 1428. While one UAV 1400 is shown, a plurality of UAVs can exist having line-of-sight propagation conditions to cells 1410, 1412, 1414 and 1416, leading to ever-increasing interference levels. Other methods for reducing interference focuses on downlink communications with ground-based UEs, and therefore cannot be applied to UAV-based causes of interference. Methods according to aspects can mitigate the interference caused by UAVs communicating on the uplink.

Methods according to aspects address UAV-based interference by incorporating an inter-cell interference coordination (ICIC) strategy. Methods apply an Almost Blank Physical Resource (ABPR) structure to UAV operation and resource allocation to restrict UAV uplink transmission. An APBR block is a resource on which interfering UAVs will be prevented from transmitting, according to aspects described below. Based on the uplink interference levels caused by UAVs, methods according to some aspects can categorize UAVs. For example, one UAV may be classified as a strong aggressor, another UAV can be classified as a weak aggressor, and yet another UAV can be categorized as a non-aggressor. Methods can apply semi-static and dynamic resource allocation strategies to schedule different types of UAVs and ground UEs. Further, methods according to some aspects can fine-tune UAV transmission power to further mitigate UAV-based interference.

Methods according to aspects can implement ICIC-based strategies by muting UAV uplink transmission in some resources (whether time-based (time division duplex (TDD) resources or frequency-based frequency division duplex (FDD) resources), allowing the ground UEs suffering from strong UAV interference to be scheduled with better signal quality. Methods according to aspects can categorize UAVs based on level of interference generated by a given UAV. Methods according to some aspects can then provide an ICIC ABPR pattern design and perform semi-static or dynamic resource allocation based on that pattern design and further based on system requirements. Methods can also be used to design scheduling rules for different types of UAV and ground UEs based on the ICIC ABPR pattern.

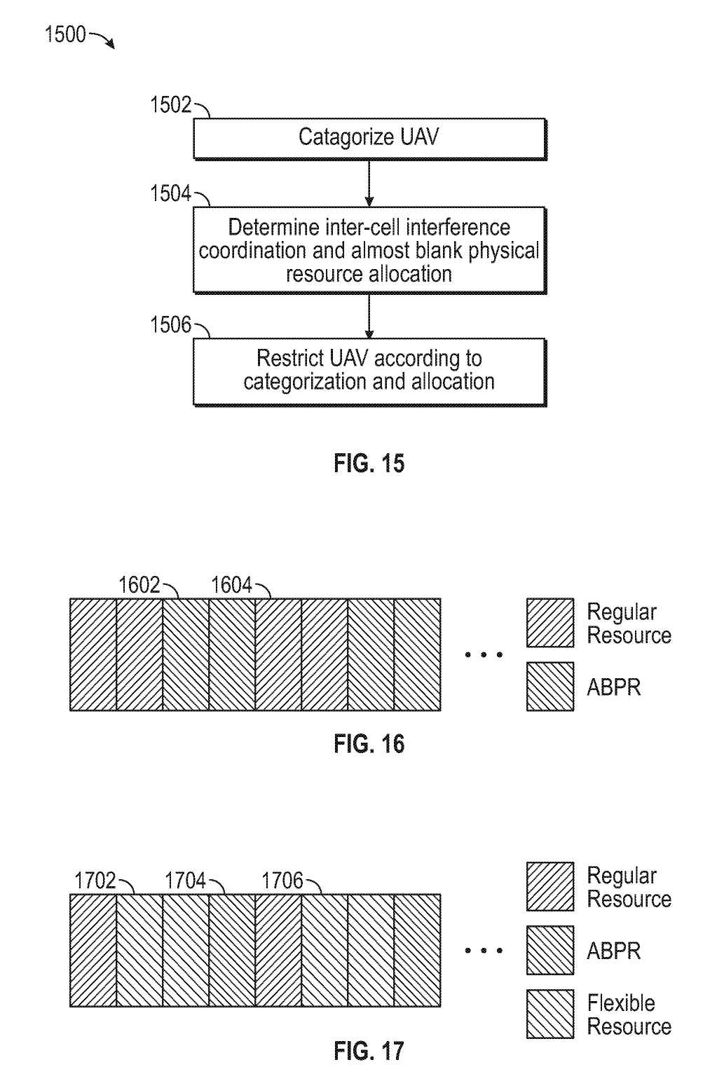

FIG. 15 illustrates a method 1500 for performing inter-cell interference coordination (ICIC) according to some aspects. Some operations of the method can be performed by BS 700 components, for example, processing circuitry 701 (FIG. 7).

The method 1500 begins with operation 1502 with the processing circuitry 701 categorizing a UAV (e.g., UAV 1400 (FIG. 14)). For example, when UAV 1400 associates with a BS (e.g., one of cells 1410, 1412, 1414, 1416), the BS can perform interference measurement and detection during a reference signal measurement period. The processing circuitry 701 can categorize the UAV 1400 into two or three different categories, depending on the granularity of measurement. For example, in aspects having a low granularity, a UAV can be categorized as being an aggressor or a non-aggressor based on whether interference caused by that UAV is above or below a threshold (e.g., threshold₁). The value for threshold) can be set based on network needs, number of UAVs, number of BS's, or other criteria.

In other examples, more than one threshold can be used, and a UAV can be categorized according to the level at which the UAV is an aggressor. For example, if a UAV interferes at a level above a high threshold, the UAV may be categorized as a strong aggressor. If the UAV interferes at a level below the high threshold, but at a level above a lower threshold, the UAV may be categorized as a weak aggressor. If the UAV interferes at a level below the lower threshold, the UAV may be considered a non-aggressor. More than two categories and thresholds can be used.

In operation 1504, the processing circuitry 701 can determine ABPR patterns and performs resource allocation. Because ground-based UEs at a cell edge are more affected by the UAV interference due to weak signal strength at the edge, UEs at the cell edge typically are allocated resources in an ABPR and are also typically granted higher scheduling priority.

In operation 1506, the processing circuitry can restrict UAVs based on categorization determined in operation 1502. If a UAV has been categorized as an aggressor (based upon result of operation 1502 above), then that UAV may not be scheduled in an ABPR, to prevent excessive interference to UEs at the cell edge. In some example aspects, a UAV that is categorized as a strong aggressor can be restricted from being scheduled in an ABPR. A weak aggressor may be scheduled in an ABPR (e.g., be permitted to operate in an APBR block), but with reduced transmission power. A non-aggressor may be scheduled without restriction in the ABPR. Ground-based UEs not at a cell edge can be scheduled in any resource. The processing circuitry 701 can set the ABPR muting pattern used for UAVs for packet scheduler and link adaptation.

The ABPR muting pattern is the number of physical resources (whether time-based of frequency-based) configured with ABPR for UAVs. This pattern can be adjusted to adapt to traffic and interference conditions to meet performance criteria for the network. Also, the design of the UAV ABPR muting pattern can consider the existing hybrid automatic repeat request (HARQ) feedback pattern. For example, either the processing circuitry 701 may develop an ABPR muting pattern that avoids ABPR in a HARQ retransmission resource or the processing circuitry 701 can reconfigure the HARQ retransmission into other resource if the HARQ retransmission is configured to use an ABPR.

In some aspects, ABPR pattern adaptation can be performed according to a static or semi-static strategy. In at least these aspects, resources can include ABPR resources 1602 and regular (non-ABPR) resources 1604 as depicted in FIG. 16. Table 3 summarizes the UE categorization for scheduling restriction under semi-static resource allocation, where √ denotes that a UE can be scheduled in the corresponding type (ABPR or regular) of resource, and x denotes that a UE cannot be scheduled in the corresponding type of resource.

TABLE 3
UE categorization for scheduling restriction
with semi-static resource allocation.

| UE categorization | Regular resources | ABPR resources |
|---|---|---|
| Center ground UE | ✓ | ✓ |
| Cell-edge ground UE | x | ✓ (with scheduling priority) |
| Strong aggressor UAV | ✓ | x |
| Weak aggressor UAV | ✓ | ✓ (with reduced power) |
| Non-aggressor UAV | ✓ | ✓ |

In some aspects, ABPR pattern adaption can be performed according to a dynamic strategy. FIG. 17 illustrates dynamic resource allocation for UAV uplink operation according to some aspects. In at least these aspects, at least some resources (e.g., “flexible” resources) 1702 can be dynamically adapted to be either APBR or regular resources. The allocation can also include ABPR resources 1704 and regular resources 1706. Center ground UEs and non-aggressor UAVs can still be scheduled in any resources. Cell-edge ground UEs have higher priority in scheduling during ABPR and flexible resource used as ABPR. Strong aggressor UAVs cannot be scheduled in ABPR and flexible resource used as ABPR, while weak aggressor UAVs can be scheduled with reduced transmit power in ABPR and flexible resources used as ABPR. Table 4 summarizes the UE categorization for scheduling restriction under dynamic resource allocation.

UE categorization for scheduling
restriction in different resources

| | Regular | APBR | Flexible |
|---|---|---|---|
| | resource | resource | resource |
| Center | ✓ | ✓ | ✓ |
| ground | | | |
| UE | | | |
| Cell-edge | x | ✓ (scheduled | ✓ (can be |
| ground | | with high | scheduled in |
| UE | | priority) | flexible resource |
| | | | is ABPR) |
| Strong | ✓ | x | x (can't be |
| aggressor | | | scheduled if |
| UAV | | | flexible resource |
| | | | is ABPR) |
| Weak | ✓ | ✓ (scheduled | ✓ (can be |
| aggressor | | with reduced | scheduled with |
| UAV | | transmit power) | reduced transmit |
| | | | power if |
| | | | flexible resource |
| | | | is ABPR) |
| Non- | ✓ | ✓ | ✓ |
| aggressor | | | |
| UAV | | | |

Note that the number of flexible time-frequency resources can be configured according to system requirements (e.g., performance requirements, number of UEs at cell edge, interference levels, etc.). More dynamic ABPR adaptation can be achieved by increasing the number or percentage of flexible resources within a given block of resources.

Referring again to FIG. 14, in order to perform ICIC, it will be appreciated that more than one cell (e.g., cells 1410, 1412, 1414 and 1416) can perform the operations of method 1500, and results of such operations can be communicated among neighboring cells. For example, ABPR patterns should be communicated between cells (1410, 1412, 1414 and 1416). Such communication can be performed over X2 communication links. In some aspects, a cell 1410, 1412, 1414 or 1416 may serve only UAVs, or serve only ground-based UEs. Cells 1410, 1412, 1414 or 1416 that serve only UAVs may still adapt or change ABPR muting based on information received from other cells that serve ground-based UEs. In some examples, a UAV can request ABPR muting patterns from one of the cells 1410, 1412, 1414, or 1416 and report the muting pattern or other information to another of cells 1410, 1412, 1414 or 1416. Any cell 1410, 1412, 1414 or 1416 can also transmit requests for information regarding usage of ABPR resources, number of cell-edge ground-based UEs supported, or other information to use for ICIC. Any cell 1410, 1412, 1414 or 1416 can notify other cells when a UAV is coming into the vicinity so that the other cells 1410, 1412, 1414 or 1416 can adapt ABPR muting patterns.

### Flight Path and Measurement Report Trigger for UAVs

Reference Signal Received Power (RSRP) can change based on distance of a UE from a BS. For ground-based UEs, RSRP degrades smoothly with distance from the BS. For UAVs, however, elevation-based fluctuations can occur due to cell quality fluctuations between nulls and side lobes. Fluctuations can have a time-based pattern based on UAV location, height, speed, and heading. As UAV elevation increases, fluctuations can be more dramatic. Fluctuations in RSRP can make handovers and interference mitigation more difficult. However, by providing flight path information, UAVs can help BS's arrange for improved handover and interference mitigation because BS's can then predict where reported RSRP may next fluctuate.

Methods and apparatuses according to some aspects provide enhancements to measurement reporting mechanisms for UAVs. In some aspects, a UAV can report flight path information to one or more BS/s. Reporting of this information can be triggered according to various mechanisms described herein. Aspects also provide methods and mechanisms for providing measurement reports of signal quality, 3D position, 3D velocity, and other measurement reports without contributing or causing excessive signaling overhead in the network.

In some aspects, the BS 1802 or other network element can configure a report update interval for UAVs to trigger a periodic flight path update report to the BS 1802. The flight path update report can include indications of one or more waypoints on the UAV flight path throughout the update interval. In another aspect, the BS 1802 or other network element can send a control message to request that a UAV report flight path information. The control message can specify a 3D region of interest (ROI), such as the serving cell coverage area. The flight path report may contain the expected timing of the UAV leaving or entering the 3D ROI. The flight path report may indicate one or multiple waypoints on the UAV flight path over the 3D ROI and the corresponding timing of the UAV traveling to those waypoints. The control message may be sent upon the BS 1802 receiving an RRC connection reconfiguration complete message from the UAV, or responsive to the BS 1802 receiving a measurement report from UAV indicating that UAV elevation exceeds a threshold.

In another aspect, the BS 1802 can configure, determine, or detect 3D poor coverage regions. The BS 1802 can instruct the UAV to trigger a flight path report when the UAV is about to, or plans to, enter a 3D poor coverage region. In at least these aspects, the flight path report may include the expected timing of the UAV leaving or entering the 3D poor coverage region. In another aspect, the BS 1802 can further provide a timing margin and instruct the UAV to trigger a measurement report and/or flight path report when the UAV plans to travel into the 3D poor coverage region within a time duration specified by the timing margin.

In any of the above aspects, and in other aspects, the 3D region can be specified in Cartesian coordinates, or according to longitude, latitude, altitude, based on vertices of the 3D region. The 3D region can be specified by a rectangular cuboid bounded by a minimum and a maximum longitude, a minimum and a maximum latitude, and a minimum and a maximum altitude. In other aspects, the 3D region can be specified in spherical coordinates, and the 3D region can be specified as the area bounded by a minimum and/or a maximum of radial distance, a minimum and/or a maximum of polar angle, and/or a minimum and/or a maximum of azimuthal angle.

The BS antenna beam null pattern is a static configuration that can be provided by the network to UAVs for better measurement and flight path report triggering. In some aspects, by comparing the ratio of ‘BS-UAV height difference’ h_{diff} and ‘BS-UAV 2D distance’ d_{2D} to thresholds described later herein, and further with the use of UAV speed information v_{z} and v_{xy}, flight path update reports can be triggered efficiently to enable proper interference mitigation and mobility management for UAVs. The two-dimensional (2D) distance between BS and UAV is defined as the distance between the projection points of the BS and the UAV onto the sea level ground.

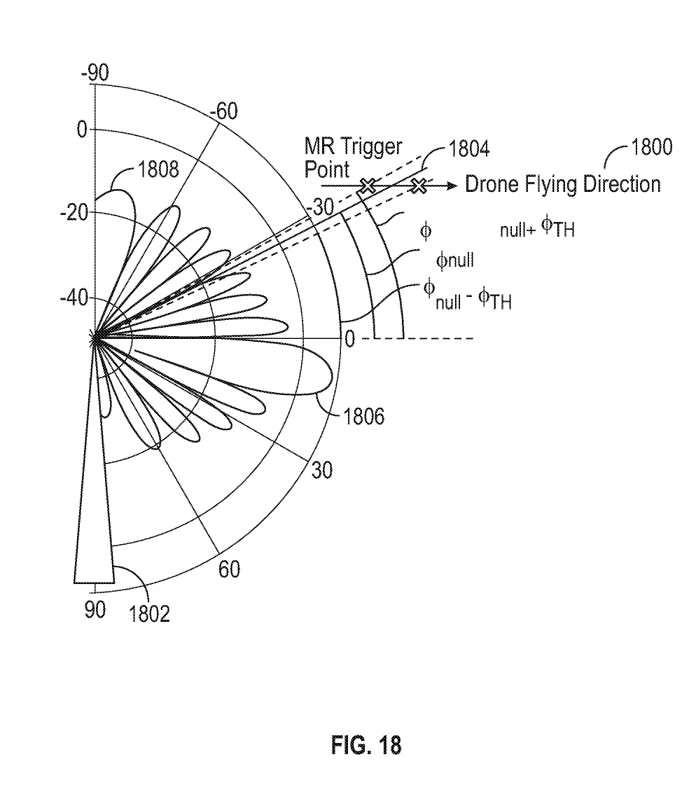

With reference to FIG. 18, a UAV may fly in direction 1800. BS 1802 has a beam null region 1804 main lobe 1806 and side lobes 1808. In some aspects, a flight path update report may be triggered if the UAV is expected to enter the beam null region 1804, within time Δt or within some other time frame. In some aspects, the flight path update report may be triggered if the UAV will be in the beam null region 1804 for longer than time T.

In an aspect, the BS 1802 can configure slope threshold pairs, where each pair contains one lower slope threshold TH_{L} and one upper slope threshold TH_{U}, with the slopes being based on the angles Øₙᵤₗₗ and Ø_{TH} relative to the horizontal as depicted in FIG. 18 and according to:

TH_{L}=tan(Øₙᵤₗₗ−Ø_{TH}) (4)

TH_{U}=tan(Øₙᵤₗₗ+Ø^{TH}) (5)

The BS 1802 can instruct the UAV to trigger a measurement report or flight path report if the ratio of h_{diff} to d_{2D} is between the lower slope threshold TH_{L} and the upper slope threshold TH_{U}:

$${TH}_{L} < \frac{{h}_{diff}}{\vert {d}_{2 d} \vert} < {TH}_{U} \qquad ( 6 )$$

In some aspects, the BS 1802 can configure one or more speed or velocity thresholds for the UAV, and instruct the UAV to trigger a measurement report based at least in part on whether the UAV velocity or speed is within ranges specified by the thresholds. In some aspects, the BS 1802 configures one or more pairs of slope thresholds, where each pair contains one lower slope threshold and one upper slope threshold, configures two timing thresholds, and instructs the UAV to trigger a measurement report if the ratio of ‘the difference between BS height and expected UAV height during the two timing thresholds’ and ‘the 2D distance between the BS and expected UAV location during the two timing thresholds' is between the lower slope threshold and upper slope threshold specified in one of the slope threshold pairs.

### Methods to Enhance End-to-End Support for Drone Wireless Communication

As described earlier herein with respect to some aspects, UAVs can experience co-channel interference because UAVs have line-of-sight to a plurality of neighboring cells. In certain regions in the air, while UAVs are in flight, SINR can become low, making it difficult for UAVs to maintain a control channel connection and leading to radio link failure. Furthermore, BS antennas are typically tilted downwards for better ground coverage, so that UAVs flying overhead are supported by side lobes. Link quality can fluctuate as UAVs travel between coverages by various side lobes.

Directional antennas can enhance signal quality. UAVs can point directional antennas to a serving BS to enhance SINR and to improve handover (HO) performance. However, when a UAV uses the directional antenna, the UAV may not trigger the HO procedure until the UAV is very far away from the serving BS. Therefore, the HO may occur under undesirable channel conditions, which may cause HO failure or radio link failure.

Aspects can enhance end-to-end support for UAVs that are equipped with directional antennas by triggering the HO procedure at a time in which signal quality is sufficient for control signaling and other HO signaling.

UAVs according to some aspects can be similar to the UE 704 shown in FIG. 7, and aspects can be implemented by components of the UE 704 (e.g., antennas 710, and processing circuitry 706). As described earlier herein with respect to FIG. 7, the UE 704 can include a two-antenna 710 receiving structure that includes at least one omni-directional antenna and at least one directional antenna. Processing circuitry 706 can cooperate with the at least one omni-directional antenna and at least one directional antenna to implement algorithms for determining a composite receiving strategy at the UE 704, including hybrid schemes, power combining schemes, and dynamic beam shaping schemes, that utilizes omni-directional antennas and directional antennas.

In aspects implementing a hybrid scheme, the UAV can measure RSRP using only an omni-directional antenna, and the HO process can be triggered based on this measured RSRP. In at least these aspects, the UAV can use the directional antenna to maintain a communication link for data and control messages, while the omni-directional antenna is used to measure RSRP. If the UAV does not include an omni-directional antenna, the UAV can perform internal calibration to convert the measured RSRP (based on the directional antenna) to an omni-antenna RSRP value. The UAV can then provide the converted RSRP in a feedback measurement report for triggering the HO process.

In aspects implementing a power combining scheme, the UAV can measure RSRP from two antennas (e.g., omni-directional and directional antennas), and then perform a dynamic combination method to add the combined power together to get the resulting RSRP for triggering the HO process. In at least these aspects, when the SINR for the serving cell of a UAV is high, the UAV only activates the UAV directional antenna for communication. Once the SINR for the serving cell falls below a certain threshold, the UAV activates a dynamic beam shaping strategy, which minimizes the usage of the UAV directional antenna while maximizing the usage of the omni-directional antenna and maintaining SINR for the current serving cell. When the SINR for the serving cell falls below the threshold, it is likely that the RSRP for other BS's (other than the current serving cell) is stronger, and that HO will be triggered.

The power combining scheme solves an optimization problem (e.g., at (7) below) to determine the minimum portion α of RSRP to take from the UAV directional antenna (where 1−α is therefore the portion of RSRP taken from the UAV omni-directional antenna). In the problem described below at (7), first let s be the index of the UAV's current serving cell, Rᵢ^{d} be the RSRP measured by the UAV directional antenna for BS i, Rᵢ^{o} be the RSRP measured by the UAV omni-directional antenna for BS i, and N₀ be the noise power. If γ(t) is the SINR for the serving cell of a UAV at time t, and given a target SINR γ_{target} and a quality parameter Q, if γ(t)≥γ_{target}, then the UAV only activates the UAV directional antenna; otherwise, the UAV takes α of RSRP from the UAV directional antenna and 1−α from the UAV omni-directional antenna for at least a period of time (e.g., 200 milliseconds):

$$\begin{matrix}{min}_{α} & α \\ subject to & \frac{α {R}_{s}^{d} + ( 1 - α ) {R}_{s}^{o}}{{N}_{0} + {\sum }_{i \neq s} α {R}_{i}^{d} + ( 1 - α ) {R}_{i}^{o}} \geq Q \\ & 0 \leq α \leq 1.\end{matrix} \qquad ( 7 )$$

Since the above optimization problem has only a linear objective function and linear constraints, the solution can be expressed in closed-form:

$$α = max \{ min \{ 1 , \frac{Q \{ ( {N}_{0} + {\sum }_{i \neq s} {R}_{i}^{o} ) - {R}_{s}^{o} \}}{{R}_{s}^{d} - {R}_{s}^{0} - Q {\sum }_{i \neq s} ( {R}_{i}^{d} - {R}_{i}^{o} )} \} , 0 \} \qquad ( 8 )$$

The power combining scheme described herein can be applied when each antenna received signal power is measured/calibrated so that the composite received energy can be added up from two antennas.

In aspects implementing a dynamic combination scheme, the UAV can combine the signal received from two antennas (e.g., omni-directional and directional antennas) and use receive beamforming to perform dynamic beam shaping. In at least these aspects, the scheme considers how the two antennas are positioned relative to each other. In at least these aspects, when the SINR for the serving cell of a UAV is high, the UAV only activates the UAV directional antenna for communication. Once the SINR for the serving cell falls below a certain threshold, the UAV can activate a dynamic beam shaping strategy.

Methods according to aspects using the dynamic beam shaping scheme solve optimization problems as described below to determine the best combination of directional and omni-directional antenna usage that maximizes omni-directional antenna usage while still maintaining RSRP for the current serving cell. For each UAV, let R_{d}, Rₒ be the RSRP for the serving cell measured by the UAV directional and omni antennas, respectively. Let M_{d}=\sqrt{R_{d}}, Mₒ=\sqrt{Rₒ} be the corresponding signal strength. Assume that the two antennas are aligned vertically with spacing d between them. Given a target SINR γ_{target} and a parameter Q, if γ(t)≥γ_{target}, then the UAV only activates the UAV directional antenna, otherwise, the resulting composite RSRP is expressed as

$${\vert α {M}_{d} {e}^{j ϕ} + β {M}_{o} {e}^{j \frac{2 π}{λ} d cos θ} {e}^{j ϕ} \vert}^{2} ,$$

where λ, θ and φ are the wavelength, vertical incident angle, and random phase of the signal, respectively, with α being the gain of the directional antenna and β being the gain of the omni-directional antenna, α is to be minimized according to the optimization problem (9):

$$\begin{matrix}{min}_{α , β ∈ ℂ} & \vert α \vert \\ subject to & \vert α {M}_{d} {e}^{j ϕ} + β {M}_{o} {e}^{j \frac{2 π}{λ} d cos θ} {e}^{j ϕ} \vert \geq Q , \\ & {\vert α \vert}^{2} + {\vert β \vert}^{2} = 1.\end{matrix} \qquad ( 9 )$$

Note that α, β can be expressed as products of their magnitudes and phases, i.e., α=\tilde{α}e^{jφ}^{_{α}}, β=\tilde{β}e^{jφ}^{_{β}} with \tilde{α}, \tilde{β}≥0.

For a given \tilde{α}, \tilde{β}≥0,

$$\vert α {M}_{d} {e}^{j ϕ} + β {M}_{o} {e}^{j \frac{2 π}{λ} d cos θ} {e}^{j ϕ} \vert$$

is maximized when

$${ϕ}_{α} = - ϕ , {ϕ}_{β} = - ( ϕ + \frac{2 π}{λ} d cos θ ) .$$

The magnitudes can therefore be optimized by solving the optimization problem at (10):

$$\begin{matrix}{min}_{\tilde{α} , \tilde{β} ∈ ℝ} & \tilde{α} \\ & \tilde{α} {M}_{d} + \tilde{β} {M}_{o} \geq Q , \\ subject to & {\tilde{α}}^{2} + {\tilde{β}}^{2} = 1 , \\ & \tilde{α} , \tilde{β} \geq 0\end{matrix} \qquad ( 10 )$$

The optimization problem (10) can be solved by considering two cases. In the first case, when Mₒ≥Q \tilde{α}=0, \tilde{β}=1 can be verified as the optimal solution, and only the omni-directional antenna will be used. In the second case, when Mₒ<Q from the second constraint one can see that

\tilde{β}=\sqrt{1−\tilde{α}²} (11)

Substituting (11) into the first constraint, we have

\tilde{α}M_{d}+\sqrt{1−\tilde{α}²}Mₒ≥Q (12)

Solving (12) for \tilde{α}, we get

$$\frac{{QM}_{d} - \sqrt{{Q}^{2} {R}_{d} - ( {R}_{d} + {R}_{o} ) ( {Q}^{2} - {R}_{o} )}}{{R}_{d} + {R}_{o}} \leq \tilde{α} \leq \frac{{QM}_{d} + \sqrt{{Q}^{2} {R}_{d} - ( {R}_{d} + {R}_{o} ) ( {Q}^{2} - {R}_{o} )}}{{R}_{d} + {R}_{o}} \qquad ( 13 )$$

Since our goal is to minimize \tilde{α}, the solution is

$$\tilde{α} = max \{ \frac{{QM}_{d} - \sqrt{{Q}^{2} {R}_{d} - ( {R}_{d} + {R}_{o} ) ( {Q}^{2} - {R}_{o} )}}{{R}_{d} + {R}_{o}} , 0 \} \qquad ( 14 )$$

if the result of Equation (14) is less than or equal to 1; otherwise the problem is not feasible and we take \tilde{α}=1, which signifies that only the directional antenna is used.

### Elevation Triggered for Aerial UE

As described earlier herein, Reference Signal Received Power (RSRP) can change based on distance of a UE from a BS. For ground-based UEs, RSRP degrades smoothly with distance from the BS. For UAVs, however, elevation-based fluctuations can occur due to cell quality fluctuations between nulls and side lobes. Fluctuations can have a time-based pattern based on UAV location, height, speed, and heading. As UAV elevation increases, fluctuations can be more dramatic. Fluctuations in RSRP can make handovers and interference mitigation more difficult. However, by providing measurement information at certain elevations, UAVs can help BS's arrange for improved handover and interference mitigation because BS's can then predict where reported RSRP may next fluctuate.

Methods and apparatuses according to some aspects provide enhancements to measurement reporting mechanisms for UAVs. In some aspects, a UAV can be triggered to send measurement report to a network based on elevation. The UAV can include components similar to those described with respect to FIG. 7. For example, the UAV can include radio transceiver circuitry 708 to receive configuration information from a BS or other network element, including configuration information indicating elevation values at which the UAV is to transmit measurement reports. The UAV can further include processing circuitry 706 to trigger a measurement report responsive to detecting that the UAV has reached an elevation specified in the configuration information.

In some aspects, a BS can configure one or more elevation values at which a UAV should transmit a measurement report to the BS. In some aspects, the BS can configure a starting elevation and delta values at which the UAV should transmit a measurement report. For example, the BS can configure the UAV to transmit a measurement report when the UAV has reached 100 meters elevation, and every 50 meters thereafter. In some aspects, the BS can further configure the UAV to terminate transmitting measurement reports above a certain elevation. For example, the BS can configure the UAV to transmit measurement reports at an elevation of 100 meters, and every 50 meters thereafter of increased elevation, until the UAV reaches an elevation of 250 meters.

In some aspects, the BS can configure the UAV to transmit measurement reports when the UAV has increased elevation by a value. For example, when the UAV elevation is at x meters, the BS can configure a value of y meters such that the UAV will send a measurement report when the UAV has achieved an elevation of x+y meters, and again at x+2y meters, etc.

In some aspects, the BS can configure a timer, the expiration of which should trigger the UAV to transmit a measurement report only if there has been an elevation change. In some aspects, the expiration of the timer should trigger the UAV to transmit a measurement report only if a minimal travel distance has been attained during that timer duration. In at least these aspects, signaling may be reduced due to the reduced need of the UAV to send measurement reports.

In some aspects, the BS can configure elevation regions or ranges in which the UAV is to transmit periodic measurement reports based on default report periodicity configured by the BS. For example, the BS can configure a region or elevation range of between 100 meters and 250 meters. When the UAV elevation is between those elevations, the UAV is to transmit a periodic measurement report according to a default periodicity (e.g., 2 seconds), wherein the default periodicity is also configured by the BS.

In some aspects, the periodicity of measurement reports can be set based on the elevation of the UAV. For example, the UAV may transmit measurement reports with a first periodicity when the UAV is at a first elevation or a first elevation range. When the UAV reaches a second elevation or elevation range, the UAV may transmit measurement reports with a different periodicity.

In some aspects, the BS configures a starting elevation value at which the UAV is to transmit measurement reports, and an ending elevation at which the UAV is to stop transmitting measurement reports, and the BS further configures a minimum travel distance at which the UAV must travel between measurement reports. For example, the UAV may be configured to transmit measurement reports every 10 meters of travel, when the UAV is at elevations of 100-250 meters. The travel distance required can vary with elevation. For example, the UAV may be configured to transmit measurement reports every 5 meters of travel when the UAV is at an elevation of 100-150 meters, and the UAV may be configured to transmit measurement reports every 10 meters of travel when the UAV is at an elevation of 151-200 meters.

In some aspects, the BS can configure a reference height, HO, above mean sea level (AMSL), above ground level (AGL), or height above average terrain (HAAT). When the UAV is above a starting elevation (D0) plus H0, then a measurement report is triggered when the UAV reaches H0+k*D0 elevation, where k>=0 is an integer. In some aspects, the reference height H0 can be accessed by the UAV from a database or other memory, and the reference height HO can be specific to the region in which the UAV is traveling.

The above detailed description includes references to the accompanying drawings, which form a part of the detailed description. The drawings show, by way of illustration, specific aspects in which the aspects of the disclosure can be practiced. These aspects are also referred to herein as “examples.” In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect. The scope of various aspects of the disclosure can be determined with reference to the appended claims, along with the full scope of equivalents to which such claims are entitled.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate aspect.

### Examples

Example 1 is an apparatus for a base station, including a radio transceiver; and processing circuitry configured to encode a message, for transmission to a user equipment (UE) configured as an unmanned aerial vehicle (UAV), to instruct the UE to measure received power received from a set of observed cells in a wireless communication network; receive a report from the UE, responsive to transmission of the message, that includes received power for the set of observed cells; determine interference power from the UE to a specified cell of the set of observed cells based on the report and further based on reported antenna gain; and determine whether to support communication of the UE within the wireless communication network based on the determined interference power from the UE.

In Example 2, the subject matter of Example 1 can include wherein the processing circuitry is further configured to specify a threshold interference power above which the UE will not be supported within the wireless communication network.

In Example 3, the subject matter of Examples 1-2 can optionally include wherein the threshold interference power is specified relative to a thermal noise value.

In Example 4, the subject matter of Examples 1-3 can optionally include wherein the report received from the UE includes a Reference Signal Received Power (RSRP) measurement.

In Example 5, the subject matter of Examples 1-4 can optionally include wherein the processing circuitry is further configured to provide an uplink (UL) resource grant to the UE to transmit cell-specific reference signals (CRS) to each of the set of observed cells.

In Example 6, the subject matter of Examples 1-5 can optionally include memory, and wherein the processing circuitry is further configured to decode antenna gain information received from the UE; and store antenna gain information in the memory.

In Example 7, an apparatus for an unmanned aerial vehicle (UAV) can include at least one antenna and processing circuitry configured to generate a three-dimensional (3D) signal map that indicates signal strengths and cell locations for a plurality of cells within a physical range of the UAV; select a serving cell from the plurality of cells based on the 3D signal map; and direct the at least one antenna to tilt in a tilt direction based on a location of the serving cell relative to the apparatus. In examples, the physical range can be a 3D range, e.g., cells may be located at an elevation removed from the UAV.

In Example 8, the subject matter of Example 7 can optionally include a location sensor, wherein the processing circuitry is further configured to rank the plurality of cells according to signal strength. In some aspects cells can be prioritized based on signal strength. The processing circuitry can store a position of each of the plurality of cells, relative to the apparatus, using the location sensor. The processing circuitry can retrieve location information, priority information, and other information for the plurality of cells. Various table-lookup or other database access algorithms can be used for this retrieval, including, e.g., hash-table-based lookup algorithms, linked-list-based lookups, binary searches, etc.

In Example 9, the subject matter of Examples 7-8 can optionally include wherein the processing circuitry is further to encode a message, for transmission to the serving cell, to report at least one of position information and signal strength information; and decode an instruction to alter the tilt direction responsive to transmission of the report.

In Example 10, an apparatus for a base station can comprise radio transceiver configured to receive transmissions from a user equipment (UE) configured as an unmanned aerial vehicle (UAV) and from a number of ground-based UEs; and processing circuitry configured to perform interference measurement based on the transmissions to categorize the UAV according to a level of interference generated by the UAV; and restrict the UAV from operating on Almost Blank Physical Resource (ABPR) blocks based on the level of interference generated by the UAV.

In Example 11, the subject matter of Example 10 can optionally include wherein the processing circuitry is further configured to categorize the UAV as a strong aggressor if the level of interference generated by the UAV is above a first threshold; categorize the UAV as a weak aggressor if the level of interference generated by the UAV is below the first threshold and above a second threshold; and categorize the UAV as a non-aggressor if the level of interference generated by the UAV is below the second threshold.

In Example 12, the subject matter of Examples 10-11 can optionally include wherein the processing circuitry is further configured to restrict the UAV from operating in the APBR blocks if the UAV is a strong aggressor; and permit the UAV to operate in the APBR blocks at a reduced transmission power if the UAV is a weak aggressor.

In Example 13, the subject matter of Examples 10-12 can optionally include wherein the processing circuitry is further configured to schedule a UE to operate within the APBR blocks if the UE is at the cell edge of the cell served by the base station.

In Example 14, the subject matter of Examples 10-13 can optionally include wherein the radio transceiver is further configured to transmit information regarding allocation of the APBR blocks to at least one neighboring cell.

In Example 15, an apparatus for a base station, the apparatus comprising a radio transceiver configured to communicate with a user equipment (UE) configured as an unmanned aerial vehicle (UAV); and processing circuitry configured to configure the UAV to provide a flight path update report; and initiate one of a mobility function and an interference mitigation function based on the flight path update report.

In Example 16, the subject matter of Example 15 can optionally include wherein the processing circuitry encodes a control message, for transmission to the UAV, to instruct the UAV to provide the flight path update report, and wherein the control message specifies that the UAV should provide the flight path update report upon entering a beam null region of the base station.

In Example 17, the subject matter of Examples 15-16 can optionally include wherein the processing circuitry encodes a control message, for transmission to the UAV, to instruct the UAV to provide the flight path update report, and wherein the control message specifies a three-dimensional (3D) a region of interest (ROI) within which the UAV is to provide the flight path update report.

In Example 18, the subject matter of Examples 15-17 can optionally include wherein the processing circuitry configures a pair of slope threshold values based on an angle, relative to the horizontal, of a null beam of the apparatus, and wherein the processing circuitry is further configured to instruct the UAV to generate a flight path update report when a ratio of height difference between the base station and the UAV to a two-dimensional distance between the base station and the UAV is between the pair of slope threshold values.

In Example 19, an apparatus for an unmanned aerial vehicle (UAV), the apparatus comprising at least one omni-directional antenna and at least one directional antenna; and processing circuitry coupled to the at least one omni-directional antenna and the at least one directional antenna and configured to determine a receiving strategy that utilizes one or both of the at least one omni-directional antenna and the at least one directional antenna to measure Reference Signal Received Power (RSRP) of a signal received from a serving cell; and encode a feedback measurement report based on the RSRP for transmission to the serving cell to trigger a handover process.

In Example 20, the subject matter of Example 19 can optionally include wherein the at least one directional antenna is activated only when a signal strength of the signal received from the serving cell falls below a threshold.

In Example 21, the subject matter of Examples 19-20 can optionally include wherein the receiving strategy includes adding the RSRP measured by each of the at least one omni-directional antenna and the at least one directional antenna to generate a composite received energy measurement.

In Example 22, the subject matter of Examples 19-21 can optionally include wherein the receiving strategy includes adding the RSRP measured by each of the at least one omni-directional antenna and the at least one directional antenna according to a proportion based at least in part upon the vertical distance between the at least one omni-directional antenna and the at least one directional antenna.

In Example 23, an apparatus for an unmanned aerial vehicle (UAV), the apparatus comprising a radio transceiver configured to receive configuration information indicating elevation values at which the UAV is to transmit measurement reports; and processing circuitry coupled to the radio transceiver and configured to trigger a measurement report responsive to detecting that the UAV has reached an elevation specified in the configuration information.

In Example 22, the subject matter of Example 23 can optionally include wherein the configuration information further includes at least one elevation delta value, and wherein the processing circuitry is configured to trigger a second measurement report, subsequent to a first measurement report, upon reaching an elevation greater than or equal to an elevation of the UAV at the time of the first measurement report plus the elevation delta value.

In Example 23, a method for performing any operations described above in Examples 1-22.

In Example 24, a computer-readable media including instructions for performing any operations described above in Examples 1-22.

In Example 25, a system including means for performing any operations described above in Examples 1-22.

In Example 26, an apparatus for computing, comprising (or a method, base station, user device or base station device for): means to receive, at an aerial user equipment (UE), a configuration communication from a network including one or more elevation values; and, at each of the one or more elevation values: means to obtain measurements; and means to send a measurement report to the network.

In Example 27, the subject matter of example 26, or other example herein, wherein the one or more elevation values includes a starting elevation value and a delta value.

In Example 30, the subject matter of example 27, or other example herein, wherein the starting elevation value is 100m, and the delta value is 50m.

In Example 31, the subject matter of example 26, or other example herein, wherein the one or more elevation values includes a starting elevation value, a delta value and a stopping value.

In Example 32, the subject matter of example 29, or other example herein, wherein the starting elevation value is 100m, the delta value is 50m, and the stopping value is 250m.

In Example 33 the subject matter of example 26, or other example herein, wherein the one or more elevation values further includes a change of elevation value, and wherein at each integer multiple of the change value the means to obtain is to obtain measurements, and the means to send to send a measurement report to the network.

In Example 34 may include the subject matter of example 26, or other example herein, wherein the configuration communication further configures a timer, which, when it expires, the means to send is to send a new measurement report to the network after an elevation change.

In Example 35 the subject matter of example 26, or other example herein, wherein the configuration communication may include a starting elevation value and a stopping elevation value, and further provide that within a configured elevation range, the means to obtain is to obtain measurements, and the means to send to is to send periodic measurement reports to the network based on a default report period configured by the network.

In Example 36, the subject matter of example 35, or other example herein, wherein the configured elevation range is between 100m and 250m and the means to obtain is to obtain measurements, and the means to send to is to send periodic measurement reports to the network at a 2 s period within the range.

In Example 37, the subject matter of example 26, or other example herein, wherein the configuration communication may further include different reporting periodicities for the one or more elevation values, and wherein the means to obtain is to obtain a measurement, and the means to send is to send a measurement report to the network, periodically, according to the configured periodicity for each elevation value.

In Example 38 the subject matter of example 26, or other example herein, wherein the configuration information further includes a delta travel distance, wherein within a configured elevation range, the means to obtain is to obtain a measurement, and the means to send to send a measurement report to the network, if a distance between a current location and the location of an immediately prior measurement report location is greater than the delta travel distance.

In Example 39 the subject matter of example 38, or other example herein, wherein the delta travel distance varies with elevation.

In Example 40 the subject matter of example 38, or other example herein, wherein the configuration information further includes a prohibit timer to avoid the means to obtain obtaining, and the means to send sending, too frequent measurement reports based on the delta travel distance.

In Example 41 the subject matter of example 26, or other example herein, wherein the one or more elevation values includes a reference height, H0, a starting elevation delta D0 and a delta D, and wherein when the UE is above H0+D0, the means to obtain is to obtain a measurement, and the means to send to send a measurement report, for each elevation H0+k*D0, where k is an integer >=0.

In Example 42, the subject matter of example 41, or other example herein, wherein H0 is specified as one of: AMSL (above mean sea level), AGL (above ground level), or HAAT (height above average terrain).

In Example 43, the subject matter of example 41, or other example herein, further comprising means to obtain HO from one of an onboard or a network database.

The above description is intended to be illustrative, and not restrictive. For example, the above-described examples (or one or more aspects thereof) may be used in combination with others. Other aspects may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as aspects may feature a subset of said features. Further, aspects may include fewer features than those disclosed in a particular example. Thus, the following claims are hereby incorporated into the Detailed Description, with a claim standing on its own as a separate aspect. The scope of the aspects disclosed herein is to be determined with reference to the appended claims, along with the full scope of equivalents to which such claims are entitled.

1. An apparatus for a base station, the apparatus comprising:
a radio transceiver; and
processing circuitry configured to
encode a message, for transmission to a user equipment (UE) configured as an unmanned aerial vehicle (UAV), to control the UE to measure received power received from a set of observed cells in a wireless communication network;
receive a report from the UE, responsive to transmission of the message, that includes received power for the set of observed cells;
determine interference power from the UE to a specified cell of the set of observed cells based on the report and further based on reported antenna gain; and
determine whether to support communication of the UE within the wireless communication network based on the determined interference power from the UE.

2. The apparatus of claim 1, wherein the processing circuitry is further configured to:
determine a threshold interference power above which the apparatus will refrain from supporting the UE within the wireless communication network.

3. The apparatus of claim 2, wherein the threshold interference power is specified relative to a thermal noise value.

4. The apparatus of claim 1, wherein the report received from the UE includes a Reference Signal Received Power (RSRP) measurement.

5. The apparatus of claim 1, wherein the processing circuitry is further configured to provide an uplink (UL) resource grant to the UE to transmit cell-specific reference signals (CRS) to each of the set of observed cells.

6. The apparatus of claim 1, further comprising memory, and wherein the processing circuitry is further configured to:
decode antenna gain information received from the UE; and
store antenna gain information in the memory.

7. An apparatus for a base station, the apparatus comprising:
a radio transceiver configured to receive transmissions from a user equipment (UE) configured as an unmanned aerial vehicle (UAV) and from a number of ground-based UEs; and
processing circuitry configured to
perform interference measurement based on the transmissions to categorize the UAV according to a level of interference generated by the UAV; and
restrict the UAV from operating on Almost Blank Physical Resource (ABPR) blocks based on the level of interference generated by the UAV.

8. The apparatus of claim 7, wherein the processing circuitry is further configured to:
categorize the UAV as a strong aggressor if the level of interference generated by the UAV is above a first threshold;
categorize the UAV as a weak aggressor if the level of interference generated by the UAV is below the first threshold and above a second threshold; and
categorize the UAV as a non-aggressor if the level of interference generated by the UAV is below the second threshold.

9. The apparatus of claim 8, wherein the processing circuitry is further configured to:
restrict the UAV from operating in the APBR blocks if the UAV is a strong aggressor; and
permit the UAV to operate in the APBR blocks at a reduced transmission power if the UAV is a weak aggressor.

10. The apparatus of claim 9, wherein the processing circuitry is further configured to:
schedule a UE to operate within the APBR blocks if the UE is at the cell edge of the cell served by the base station.

11. The apparatus of claim 8, wherein the radio transceiver is further configured to transmit information regarding allocation of the APBR blocks to at least one neighboring cell.

12. An apparatus for a base station, the apparatus comprising:
a radio transceiver configured to communicate with a user equipment (UE) configured as an unmanned aerial vehicle (UAV); and
processing circuitry configured to
configure the UAV to provide a flight path update report; and
initiate one of a mobility function and an interference mitigation function based on the flight path update report.

13. The apparatus of claim 12, wherein the processing circuitry encodes a control message, for transmission to the UAV, to instruct the UAV to provide the flight path update report, and wherein the control message specifies that the UAV should provide the flight path update report upon entering a beam null region of the base station.

14. The apparatus of claim 12, wherein the processing circuitry encodes a control message, for transmission to the UAV, to instruct the UAV to provide the flight path update report, and wherein the control message specifies a three-dimensional (3D) a region of interest (ROI) within which the UAV is to provide the flight path update report.

15. The apparatus of claim 12, wherein the processing circuitry configures a pair of slope threshold values based on an angle, relative to the horizontal, of a null beam of the apparatus, and wherein the processing circuitry is further configured to instruct the UAV to generate a flight path update report when a ratio of height difference between the base station and the UAV to a two-dimensional distance between the base station and the UAV is between the pair of slope threshold values.

16. The apparatus of claim 12, wherein the processing circuitry is further configured to trigger a measurement report responsive to detecting that the UAV has reached an elevation specified in configuration information.

17. An apparatus for an unmanned aerial vehicle (UAV), the apparatus comprising:
at least one omni-directional antenna and at least one directional antenna; and
processing circuitry coupled to the at least one omni-directional antenna and the at least one directional antenna and configured to
determine a receiving strategy that utilizes one or both of the at least one omni-directional antenna and the at least one directional antenna to measure Reference Signal Received Power (RSRP) of a signal received from a serving cell; and
encode a feedback measurement report based on the RSRP for transmission to the serving cell to trigger a handover process.

18. The apparatus of claim 17, wherein the at least one directional antenna is activated only when a signal strength of the signal received from the serving cell falls below a threshold.

19. The apparatus of claim 18, wherein the receiving strategy includes adding the RSRP measured by each of the at least one omni-directional antenna and the at least one directional antenna to generate a composite received energy measurement.

20. The apparatus of claim 18, wherein the receiving strategy includes adding the RSRP measured by each of the at least one omni-directional antenna and the at least one directional antenna according to a proportion based at least in part upon the vertical distance between the at least one omni-directional antenna and the at least one directional antenna.
